(19) United States
(12) Patent Application Publication
(10) Pub. No.: US 2026/0361700 A1
(43) Pub. Date: Nov. 12, 2026

(54) EDGE VIDEO SEARCH

(71) Applicant: NETRADYNE, INC., San Diego, CA (US)

(72) Inventors: Venkata Sreekanta Reddy Annapureddy, San Diego, CA (US); Ridham Zalawadia, San Diego, CA (US); Hrishikesh Pradeep Hippalgaonkar, San Diego, CA (US); Avneesh Agrawal, San Diego, CA (US); David Julian, Hendersonville, TN (US)

(73) Assignee: NETRADYNE, INC., San Diego, CA (US)

(21) Appl. No.: 19/669,602

(22) Filed: May 6, 2026

Related U.S. Application Data
(60) Provisional application No. 63/801,779, filed on May 7, 2025.

(51) Int. Cl. H04L 9/40; G06F 16/73; G06V 10/74; G06V 10/77; G06V 10/94; G06V 20/40; G06V 10/82

(52) U.S. Cl. CPC H04L 63/0428; G06F 16/73; G06V 10/761; G06V 10/7715; G06V 10/95; G06V 20/46; G06V 10/82

(57) ABSTRACT

A method for searching visual data at an edge device comprises generating one or more visual embeddings from video data captured by a camera associated with the edge device, wherein the one or more visual embeddings indicate semantic characteristics of visual content represented in the video data. The method comprises receiving a query embedding from a server, the query embedding corresponding to a search query. The method comprises identifying one or more matching visual embeddings from among the one or more visual embeddings retained at the edge device by comparing the query embedding with the one or more visual embeddings retained at the edge device. The method comprises identifying one or more video frames corresponding to the identified one or more matching visual embeddings and transmitting information associated with the identified one or more video frames to the server.

### CROSS-REFERENCE TO RELATED APPLICATIONS

This application claims priority to U.S. Patent Application No. 63/801,779 filed on May 7, 2025, which is hereby incorporated by reference in its entirety.

### FIELD OF THE INVENTION

The present disclosure relates to distributed visual data systems, and more particularly to methods and systems for searching visual content across edge devices.

### BACKGROUND

The information disclosed in this background section is only for the enhancement of understanding of the general background of the disclosure and should not be taken as an acknowledgement or any form of suggestion that this information forms the prior art already known to a person skilled in the art.

Visual data is now being captured at an unprecedented scale by edge devices deployed across a wide range of environments. Cameras embedded in vehicles, infrastructure, and public spaces continuously generate large volumes of visual information. This rapid proliferation of visual sensors presents a significant opportunity to derive insights across domains such as transportation, retail, public safety, and urban planning.

However, despite the abundance of visual data, challenges prevent effective utilization of such data. A primary limitation relates to bandwidth and storage constraints. The sheer volume of data generated by distributed edge devices makes it impractical to transmit all captured video to centralized servers. Even with advanced compression techniques, continuously uploading video streams from large-scale deployments would overwhelm existing network infrastructure. Similarly, the cost of storing such massive datasets in centralized repositories would be prohibitively high.

Edge-based visual data systems face multiple limitations arising from constrained processing resources, distributed storage, and system heterogeneity. Edge devices often operate under strict computational and power constraints, limiting their ability to perform advanced analytics or search functions beyond primary real-time tasks. Further, visual data is typically fragmented across distributed devices without standardized querying mechanisms, rendering conventional metadata-based search techniques ineffective for unstructured visual content.

Traditional computer vision approaches, which rely on predefined object classes and trained detectors, lack the flexibility to support open-ended or evolving queries, thereby reducing their applicability in real-world scenarios. Moreover, edge-only implementations restrict search to isolated devices, preventing cross-device insights and resulting in redundant processing. Interoperability challenges across proprietary ecosystems further exacerbate data silos, hindering unified analysis. Additionally, privacy and regulatory requirements necessitate robust protection mechanisms for sensitive visual information. The diversity of hardware platforms and camera systems introduces further complexity in developing standardized, scalable frameworks for efficient visual data processing, representation, and cross-device analysis.

Accordingly, there is a need for improved techniques that overcome the above-discussed and other related problems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure relates to methods and systems for processing visual data across distributed edge devices using embedding-based techniques.

In an embodiment, a method for searching visual data at an edge device is provided. The method includes generating, at the edge device, one or more visual embeddings from video data captured by a camera associated with the edge device. The one or more visual embeddings indicate semantic characteristics of visual content represented in the video data. The method includes receiving, at the edge device, a query embedding from a server. The query embedding corresponds to a search query. The method further includes identifying, at the edge device, one or more matching visual embeddings from among the one or more visual embeddings retained at the edge device. The one or more matching visual embeddings are identified by comparing the query embedding with the one or more visual embeddings retained at the edge device. Thereafter, the method includes identifying, at the edge device, one or more video frames corresponding to the identified one or more matching visual embeddings. The method comprises transmitting, from the edge device, information associated with the identified one or more video frames to the server.

In an embodiment, a system for searching visual data is provided. The system includes a server. The server includes one or more processors and memory storing instructions executable by the one or more processors. The system also includes a plurality of edge devices in communication with the server. Each edge device of the plurality of edge devices comprises at least one processor and memory storing instructions executable by the at least one processor. The memory of an edge device of the plurality of edge devices stores instructions that, when executed by the at least one processor of the edge device, cause the edge device to generate one or more visual embeddings from the video data captured by a camera associated with the edge device. The one or more visual embeddings indicate semantic characteristics of visual content represented in the video data. The instructions cause the edge device to receive a query embedding transmitted from the server. The query embedding corresponds to a search query. The instructions cause the edge device to identify one or more matching visual embeddings from among the one or more visual embeddings retained in the edge device by comparing the query embedding with the one or more visual embeddings. The instructions cause the edge device to identify one or more video frames corresponding to the identified one or more matching visual embeddings. The instructions cause the edge device to transmit information associated with the identified one or more video frames to the server. The memory of the server stores instructions that, when executed by the one or more processors, cause the server to receive the search query. The instructions cause the server to generate the query embedding based on the search query. The instructions cause the server to transmit the query embedding to the plurality of edge devices. The instructions cause the server to generate a search result by aggregating information received from the plurality of edge devices.

In an embodiment, a system for searching visual data across heterogeneous edge devices is provided. The system includes a server comprising one or more processors and memory; and a plurality of edge devices in communication with the server. The plurality of edge devices includes at least a first edge device and a second edge device. The first edge device includes a first camera, a first vision model, and a first adapter module. The first vision model is configured to generate first visual feature vectors in a first feature space. The first adapter module is configured to transform the first visual feature vectors into visual embeddings in a shared embedding space. The second edge device includes a second camera, a second vision model different from the first vision model, and a second adapter module different from the first adapter module. The second vision model is configured to generate second visual feature vectors in a second feature space different from the first feature space. The second adapter module is configured to transform the second visual feature vectors into visual embeddings in the shared embedding space. The memory of the server stores instructions that, when executed, cause the server to receive a search query; generate a query embedding in the shared embedding space based on the search query; transmit the query embedding to the first edge device and the second edge device for comparison against the visual embeddings stored at each respective edge device; and aggregate, into a search result, information received from the first edge device and the second edge device identifying matching video frames.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF FIGURES

These and other features, embodiments, and advantages of the present disclosure will become better understood when the following detailed description is read with reference to the accompanying drawings in which like characters represent like parts throughout the drawings, wherein:

FIG. 1 illustrates an example environment for searching visual data across distributed edge devices, in accordance with an embodiment of the present disclosure;

FIG. 2 illustrates an example edge device for searching visual data, in accordance with an embodiment of the present disclosure;

FIG. 3 illustrates a block diagram of a searching apparatus configured for use in the edge device searching visual data, in accordance with an embodiment of the present disclosure;

FIG. 4 illustrates a functional block diagram of the searching apparatus with modules for searching visual data, in accordance with an embodiment of the present disclosure;

FIG. 5 illustrates a block diagram of a generation module, in accordance with an embodiment of the present disclosure;

FIG. 6 illustrates a block diagram of a system for enabling third-party applications to search distributed visual data, in accordance with an embodiment of the present disclosure;

FIG. 7 illustrates a workflow for privacy-preserving search of visual data at an edge device, in accordance with an embodiment of the present disclosure;

FIG. 8 illustrates a system for generating semantic maps using distributed edge devices, in accordance with an embodiment of the present disclosure;

FIG. 9 illustrates a block diagram of a unified visual search framework for integrating heterogeneous camera systems, in accordance with an embodiment of the present disclosure;

FIG. 10 illustrates a flowchart for a method for searching visual data at the edge device, in accordance with an embodiment of the present disclosure;

FIGS. 11A-11B illustrate example search interfaces displaying search results, in accordance with embodiments of the present disclosure; and

FIGS. 12A-12B illustrate search interfaces displaying search results for brand detection, in accordance with an embodiment of the present disclosure.

### DETAILED DESCRIPTION

For the purpose of promoting an understanding of the principles of the disclosure, reference will now be made to the embodiment illustrated in the drawings, and specific language will be used to describe the same. It will nevertheless be understood that no limitation of the scope of the disclosure is thereby intended, such alterations and further modifications in the illustrated system, and such further applications of the principles of the disclosure as illustrated therein, being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises... a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the embodiments herein. Also, the various embodiments described herein are not necessarily mutually exclusive, as some embodiments can be combined with one or more other embodiments to form new embodiments. The term “or” as used herein refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features, and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The present disclosure provides methods and systems for searching visual data across distributed edge devices using embedding-based techniques. The techniques described herein address challenges associated with utilizing visual data captured by cameras on vehicles, in infrastructure, and in other distributed environments, while addressing bandwidth limitations, computational constraints, and privacy concerns.

In the present disclosure, the terms “feature extractor” and “vision model” are used interchangeably to refer to a component configured to process video data and produce visual feature data representative of visual content within the video data. References to a “feature extractor” in connection with a particular embodiment shall be understood as also encompassing implementations using a “vision model,” and references to a “vision model” shall be understood as also encompassing implementations using a “feature extractor.” A feature extractor or vision model as referred to herein may be implemented as a pre-trained convolutional neural network, a vision transformer, an attention-based image encoder, or any other component configured to generate visual feature representations from input video data, without limitation.

Embodiments of the present disclosure will be described below in detail with reference to the accompanying drawings.

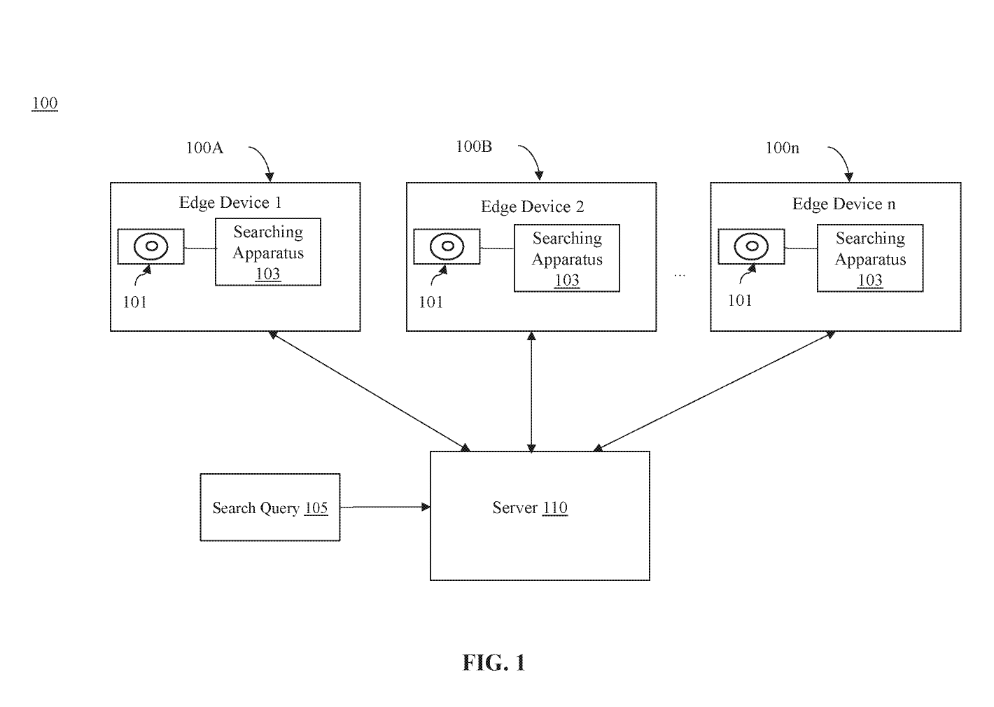

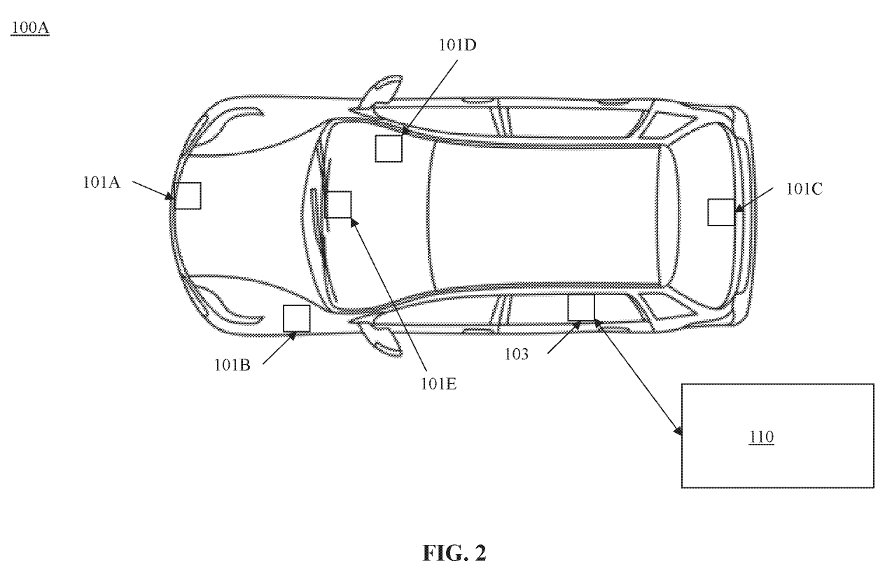

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates an example environment 100 for searching visual data across distributed edge devices, in accordance with an embodiment of the present disclosure. As shown, the example environment 100 may include a server 110 and a plurality of edge devices (herein referred to as the edge devices 100) in communication with the server 110. As shown in FIG. 1, the plurality of edge devices 100 may include an edge device 1 100A, an edge device 2 100B, through an edge device n 100n. It can be noted that the example environment 100 may accommodate any number of edge devices in a scalable configuration.

In an example embodiment, the server 110 may comprise one or more processors and memory storing instructions executable by the one or more processors. As shown in FIG. 1, each of the edge devices, i.e., edge device 1 100A, the edge device 2 100B, and the edge device n 100n, may include one or more cameras 101 (collectively referred to as the camera 101) and a searching apparatus 103. The camera 101 may be configured to capture video data of a surrounding environment. The searching apparatus 103 may be configured to process the captured video data and perform visual search operations.

A search query 105 may include a textual description of visual content to be located, an image-based query, or a combination of textual query data and visual query data. The memory of the server 110 may store instructions that, when executed by the one or more processors, cause the server 110 to process the search query 105 and generate a query embedding based on the search query 105 (e.g., by applying a text encoder for textual query data and/or by processing an image example). The query embedding may be generated in the same embedding space as the visual embeddings stored on the edge devices 100A, 100B, 100n.

The memory of the server 110 may store instructions that, when executed by the one or more processors, cause the server 110 to receive the search query 105. The instructions may cause the server 110 to generate a query embedding based on the search query 105. The query embedding may be generated in the same embedding space as the visual embeddings stored on the edge devices 100A, 100B, 100n. The instructions may cause the server 110 to transmit the query embedding to the plurality of edge devices.

The server 110 may forward the query embedding to at least one edge device from among the plurality of edge devices 100A, 100B, 100n. It should be noted that the at least one edge device may be the edge device 100A. For example, the edge device 100A may receive the query embedding transmitted from the server 110. Each edge device 100A, 100B, 100n may generate one or more visual embeddings from video data captured by its camera(s) 101 and may retain the visual embeddings in local memory (e.g., at the searching apparatus 103) for subsequent search operations. In some embodiments, the searching apparatus 103 of each of the edge devices 101 samples video frames at a predefined rate (e.g., one frame per second) and processes each sampled frame to extract visual feature data. The searching apparatus 103 also transforms the visual feature data into fixed-length embedding vectors. The fixed-length embedding vectors represent the semantic content of the respective frame. The searching apparatus 103 also stores the embedding vectors according to a retention policy that may consider the age of the data, available storage space, and potential relevance of the content.

Upon receiving the query embedding from the server 110, the edge device 100A compares the query embedding with the visual embeddings retained at the edge device 100A (e.g., stored by the searching apparatus 103) to identify one or more matching visual embeddings. The comparison may involve determining similarity scores between the query embedding and stored visual embeddings, for example, using cosine similarity or Euclidean distance. The edge device 100A may identify matches by selecting visual embeddings whose similarity scores exceed a specified threshold.

For each matching visual embedding identified at the edge device 100A, the edge device 100A identifies one or more corresponding video frames or video segments that produced the matching visual embedding. The edge device 100A then transmits, to the server 110, information associated with the identified one or more video frames or video segments. Depending on system configuration and available bandwidth, the information may include metadata such as timestamp, location, and confidence score, preview images of matching frames, and/or video segments containing the matches.

The server 110 receives responses from a plurality of edge devices 100A, 100B, 100n, and aggregates the information to generate a search result corresponding to the search query 105. In some embodiments, the aggregation includes deduplicating similar detections reported by different edge devices 100A, 100B, 100n, ranking results based on confidence scores or other relevance metrics, and formatting the ranked results for presentation to a user. The aggregated results provide a fleet-wide or system-wide view of visual content matching the search query 105 without requiring transmission of all captured video data to the server 110.

The example environment 100 enables distributed visual search by performing comparison operations at the edge devices, such as edge devices 100A, 100B, 100n, rather than transmitting raw video data to the server 110. By way of illustration, a fleet of approximately 100,000 vehicles, each generating approximately 1 GB of video data per hour of operation, may collectively produce approximately 100 TB of data per hour. Transmitting such volumes of raw video over cellular or wide-area networks may be prohibitively expensive and, in some deployment scenarios, technically infeasible due to bandwidth constraints. By contrast, in some embodiments, transmitting query embeddings to the edge devices 100A, 100B, 100n and receiving back only matching frame information or metadata may reduce per-search bandwidth utilization negligible levels in comparison to what would be required to transmit raw video to a centralized server. In some embodiments, the storage of visual embeddings on the edge devices may improve search latency, which may be measured as the time from query submission to result display, and avoid centralized retention of raw video data, thereby substantially reducing centralized storage requirements as compared to centralized video archive approaches. The visual embeddings retained on each edge device may comprise compact fixed-dimensional vectors, requiring substantially less storage per unit of video processed than the corresponding raw video data. In an example embodiment, search latency may average within a very short time, such as under 3 seconds for fleets of up to 1,000 vehicles, with results beginning to stream in after approximately 1 second. .

In some embodiments, the server 110 may receive metadata from a plurality of edge devices 100A, 100B, 100n in response to a single query embedding, and may select, based on the received metadata, a subset of the matching visual embeddings for which to request additional information. The selection may be based on one or more of: a ranking of similarity scores or confidence scores received from the plurality of edge devices, a deduplication operation that identifies multiple matching visual embeddings corresponding to a single underlying scene or object captured by different edge devices, a maximum number of results to be presented to a user, geographic distribution criteria, temporal distribution criteria, or input received from the user or from the third-party application that initiated the search query 105. The server 110 may then transmit, to a subset of the plurality of edge devices, a request for additional information corresponding to the selected subset of matching visual embeddings, and may receive the requested additional information from the subset of edge devices. By transmitting metadata in a first stage and selectively requesting richer content in a second stage, the server 110 may manage aggregate inbound bandwidth and latency in deployments comprising large numbers of edge devices.

In some embodiments, precision for common object queries may exceed 90%, while recall may range from 75% to 95% depending on object size and distinctiveness. For more specific queries, such as particular brands or specific conditions, precision may remain above 85% while recall may decrease to 60-80%. The distributed nature of the search processing may provide computational scaling, as each edge device handles comparison operations independently.

The performance characteristics described herein are achievable using edge computing hardware that is commercially available as of 2025, including embedded systems-on-chip incorporating general-purpose processors, graphics processing units, and dedicated neural network accelerators of the types deployed in commercial vehicle telematics systems and similar applications. As edge computing hardware continues to advance, embodiments of the present disclosure may operate at higher embedding generation rates, higher input image resolutions, larger embedding dimensionalities, or larger retained embedding counts per device, without departing from the scope of the methods and systems described herein. The numerical values, ranges, and performance characteristics described in this disclosure are provided as illustrative examples of particular embodiments and are not intended to limit the scope of the claims.

FIG. 2 illustrates an example edge device for searching visual data, in accordance with an embodiment of the present disclosure. The example edge device may correspond to the edge device 100A. In an example embodiment, the edge device 100A may correspond to a vehicle and is accordingly referred to as the vehicle 100A thereafter. As shown, the vehicle 100A may include the one or more cameras 101 (also referred to as one or more vehicle-mounted cameras 101) configured to capture video data of a driving environment and users within the edge device 100A. In an example embodiment, the driving environment may refer to all the surrounding conditions and elements that influence how a vehicle is operated. The driving environment may include, but is not limited to, factors such as road conditions, traffic on the road, weather, lighting, road signs, signals, lane markings, pedestrians, and other road users. The driving environment may continuously change based on location, time, and external circumstances, requiring the driver or the vehicle 100A to constantly monitor and adapt. For example, when driving in a crowded city area, the driving environment may consist of slow-moving traffic, pedestrians crossing the road, parked vehicles, traffic signals, and noise, which together require careful attention, reduced speed, and frequent braking to ensure safe navigation.

The one or more vehicle-mounted cameras 101 may include, but are not limited to, exterior cameras 101A-101C and one or more interior cameras 101D-101E. The exterior cameras 101A-101C may be positioned on external surfaces of the vehicle 100A. The exterior cameras 101A-101C may be configured to capture a view of the driving environment external to the vehicle 100A. The exterior cameras 101A-101C may include, but are not limited to, a windshield-mounted exterior-facing camera, a front bumper camera, a grill-mounted camera, a rear-view camera, side-mounted cameras, roof-mounted cameras, and surround-view cameras. In an example embodiment, the interior cameras 101D-101E may be positioned within a cabin of the vehicle 100A. The interior cameras 101D-101E may be configured to capture video data of a user, such as a driver, within the vehicle 100A. The interior cameras 101D-101E may include, but are not limited to, a driver-facing camera, a cabin-monitoring camera, an Infrared (IR) interior camera, and a gesture-recognition camera.

In an embodiment, the one or more vehicle-mounted cameras 101 may be coupled to a searching apparatus 103 configured to search the visual data. In an embodiment, the searching apparatus 103 may be a part of a control unit of the vehicle 100A. In another embodiment, the searching apparatus 103 may be connected to the control unit.

The searching apparatus 103 may be configured to process video data captured by the one or more cameras 101A, 101B, 101C, 101D, and 101E and generate visual embeddings from video frames. The visual embeddings may comprise compact numerical representations of visual content that capture semantic characteristics of visual scenes while requiring less storage space than the original video data. For example, a one-minute video segment requiring 30MB of storage may correspond to visual embeddings occupying 1MB, representing a 30x reduction in storage requirements.

In some embodiments, the searching apparatus 103 may sample video frames at a predefined rate, such as one frame per second, and process each sampled frame to extract visual features. The visual features may be transformed into fixed-length embedding vectors that represent the semantic content of the respective frame. The searching apparatus 103 may store the embedding vectors in local memory according to a retention policy that may consider factors such as age of the data, available storage space, and potential relevance of the content.

The searching apparatus 103 may communicate with the server 110 via a wireless connection. The server 110 may be configured to receive search queries and generate query embeddings based on the search queries. The server 110 may also be configured to transmit the query embeddings to the edge devices 100. The server 110 may further be configured to aggregate search results received from the edge devices 100. When a search query 105 is received at the server 110, the server 110 may process the search query 105 to generate the query embedding in the same embedding space as the visual embeddings stored on the edge device 100A. The server 110 may transmit the query embedding to the edge device 100A, and the searching apparatus 103 may compare the query embedding with the visual embeddings stored locally to identify matches. The searching apparatus 103 may transmit information about matching video frames back to the server 110, where the information may be aggregated to generate search results.

It should be noted that the techniques of the present disclosure have been explained using the edge device 100A as a reference edge device for the sake of clarity. Accordingly, the edge device may correspond to the edge device 100A, hereinafter.

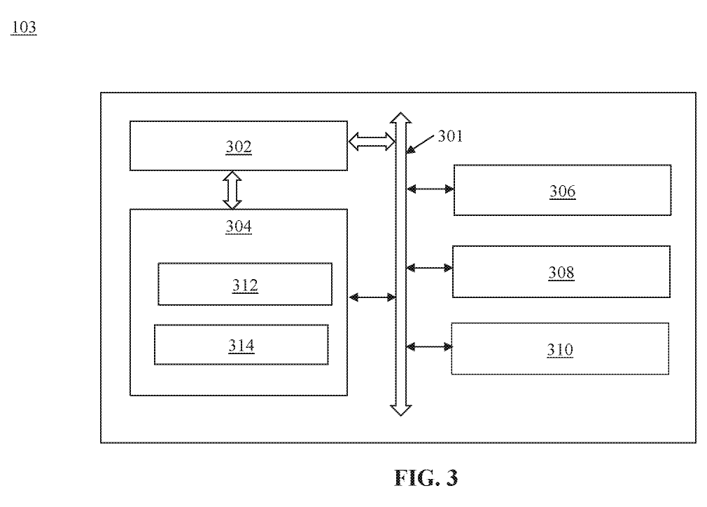

The searching apparatus 103 has been further explained in reference to FIG. 3.

FIG. 3 illustrates a block diagram of a searching apparatus 103 configured for use in an edge video search system. The searching apparatus 103 may be installed within the edge device, such as edge device 100A, or may be a part of the edge device 100A. The searching apparatus 103 may be communicatively coupled to one or more cameras 101 associated with the edge device 100A.

As shown, the searching apparatus 103 may include a bus 301, at least one processor 302, a memory 304, a communication unit 306, an Input/Output (I/O) interface 308, an output unit 310, a database 312, and modules 314.

The at least one processor 302 may be implemented as one or more microprocessors, microcomputers, microcontrollers, digital signal processors, central at least one processors, state machines, logic circuitries, or any devices that manipulate signals based on operational instructions. Among other capabilities, the at least one processor of the at least one processor 302 may be configured to fetch and execute computer-readable instructions and data stored in the memory 304. The computing capability of the searching apparatus 103 may be a Central Processing Unit (CPU) or an integrated System-on-a-Chip (SOC), which may include a CPU and other specialized compute cores, such as a Graphics Processor (GPU) and a gesture recognition processor.

With continued reference to FIG. 3, the memory 304 may include one or more computer-readable storage media that can communicate via the bus 301. The memory 304 may include non-volatile storage elements. Examples of such non-volatile storage elements may include magnetic hard discs, optical discs, floppy discs, flash memories, or forms of Electrically Programmable Memories (EPROM) or Electrically Erasable And Programmable Memories (EEPROM). The memory 304 may be considered a non-transitory storage medium. The term “non-transitory” may indicate that the storage medium is not embodied in a carrier wave or a propagated signal. However, the term “non-transitory” may not be interpreted to mean that the memory 304 is non-movable. In some cases, a non-transitory storage medium may store data that can, over time, change (e.g., in Random Access Memory (RAM) or cache). The memory 304 may further include any non-transitory computer-readable medium, including, for example, volatile memory, such as Static Random-Access Memory (SRAM) and Dynamic Random-Access Memory (DRAM), or non-volatile memory, such as Read-Only Memory (ROM), erasable programmable ROM, flash memories, hard disks, optical disks, and magnetic tapes. The memory 304 stores instructions that, when executed by the at least one processor 302, cause the at least one processor 302 to perform operations associated with searching for visual data.

The memory 304 includes the database 312 and the modules 314. The database 312 may be configured to be accessed by the at least one processor 302 and may store information as used by the at least one processor 302 to perform one or more functions. The database 312 may store video data, visual embeddings, and other information associated with driving event detection. The modules 314 include routines, programs, objects, components, data structures, and other elements that perform particular tasks or implement data types. The modules 314 may also be implemented as signal processors, state machines, logic circuitries, or any other device or component that manipulates signals based on operational instructions. The modules 314 may be implemented in hardware, instructions executed by the at least one processor 302, or by a combination thereof.

As further shown in FIG. 3, the communication unit 306 may be configured to communicate video data or any other content over a communication network via a communication port or interface or using the bus 301. The communication unit 306 may include a communication port or a communication interface for sending and receiving data via the communication network. The searching apparatus 103 may include wireless communication to cloud services, such as with Long Term Evolution (LTE) or Bluetooth communication to other devices nearby. The communication unit 306 may include a Wireless-Fidelity (Wi-Fi) module or Bluetooth module for enabling wireless communication capability and data exchange capability between various modules of the searching apparatus 103. The communication unit 306 may enable the searching apparatus 103 to communicate with external systems, such as cloud servers, for transmitting video data and receiving updated detection parameters.

The I/O interface 308 may refer to hardware or software components that enable communication between various modules of the searching apparatus 103. The I/O interface 308 may serve as a communication medium for exchanging information, commands, signals, or query responses with other devices or systems. The I/O interface 308 may be a part of the at least one processor 302 or may be a separate component. The I/O interface 308 may be created in software or may be a physical connection in hardware. The I/O interface 308 may be configured to connect with an external network, external media, a display, or any other components, or combinations thereof.

The output unit 310 may comprise a display device. The display device may be an Augmented Reality/Virtual Reality (AR/VR) device to display a virtual environment to a user. The display device may include a display screen. As a non-limiting example, the display screen may be a Light Emitting Diode (LED), Liquid Crystal Display (LCD), Organic Light Emitting Diode (OLED), Active Matrix Organic Light Emitting Diode (AMOLED), or Super Active Matrix Organic Light Emitting Diode (AMOLED) screen. The output unit 310 may be configured to present alerts or notifications related to detected driving events.

The searching apparatus 103 may also include a Global Positioning System (GPS) either as a separate module or integrated within a system-on-a-chip. The components of the searching apparatus 103 may be interconnected via the bus 301, which may facilitate communication and data transfer between the various components. The at least one processor 302 may communicate bidirectionally with the memory 304 via the bus 301. The bus 301 may also provide bidirectional communication pathways between the at least one processor 302 and the communication unit 306, the I/O interface 308, and the output unit 310.

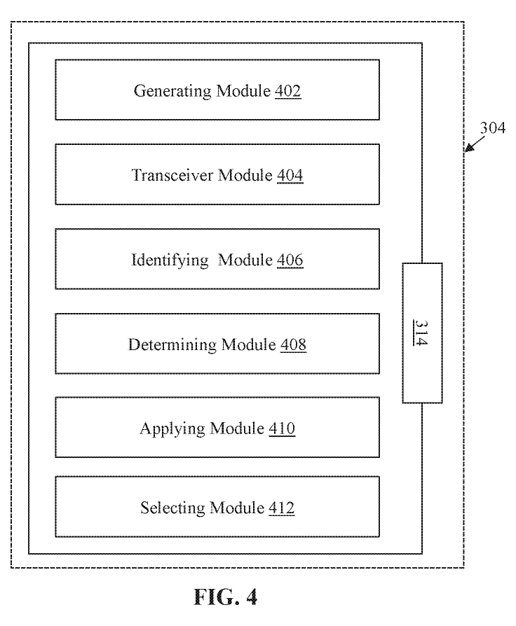

In an embodiment, the present disclosure also contemplates a computer-program product, having machine-readable instructions stored therein, when executed by the at least one processor 302, which causes the at least one processor 302 to perform the method for detecting the driving event using the video data captured by the one or more vehicle-mounted cameras 101. The details on the method(s) performed by the at least one processor 302 have been elaborated in subsequent paragraphs at least with reference to FIG. 4.

Further, the present disclosure also contemplates a non-transitory computer-readable medium encoded with executable instructions. The executable instructions, when executed by the at least one processor 302, cause the at least one processor 302 to perform the method for searching visual data. The details on the method(s) performed by the at least one processor 302 have been elaborated in subsequent paragraphs at least with reference to FIG. 4.

FIG. 4 illustrates a functional block diagram of the searching apparatus 103 with modules 314 for searching visual data, in accordance with an embodiment of the present disclosure. As shown, the modules 314 may include a generating module 402, a transceiver module 404, an identifying module 406, a determining module 408, an applying module 410, and a selecting module 412. The processor 302 may execute instructions stored in the memory 304 and coordinate the operation of the various modules to perform visual search functions on the edge device, such as edge device 100A.

In an embodiment, the generating module 402 may be configured to generate one or more visual embeddings from video data. The video data may be captured by a camera associated with the edge device 100A. For example, the video data may be captured by at least one of the one or more cameras 101, such as camera 101A. The one or more visual embeddings may indicate semantic characteristics of visual content represented in the video data. In an example embodiment, semantic characteristics may refer to high‑level, meaning‑based attributes of visual content that describe what is depicted in a scene rather than raw pixel information. Such characteristics may include, but are not limited to, presence, type, and relationships of objects (for example, people, vehicles, or infrastructure), activities or actions (such as walking, stopping, or entering), and contextual attributes like crowd density or motion patterns. For example, a video frame showing pedestrians crossing a road and vehicles halted at an intersection may be represented by semantic characteristics indicating “people,” “vehicles,” and “stopped traffic,” without encoding exact visual details such as individual faces or textures. These semantic characteristics enable the visual embeddings to support meaningful search and comparison with natural‑language queries while remaining compact and privacy‑preserving. In some embodiments, the one or more visual embeddings may comprise fixed-dimensional vector representations of the semantic characteristics of the video data. For example, if the camera 101A records a short video of a crowded street with vehicles and pedestrians, the generating module 402 may analyze each video frame and produce a fixed‑dimensional vector, such as a 512‑dimensional embedding for that frame. The visual embeddings may comprise predefined floating-point values per frame, such as 512, requiring approximately, for example, 2 kilobytes of storage per embedding when using 32-bit precision. Each of the 512 floating‑point values encodes different semantic aspects of the visual content, such as the presence of cars, people, or movement patterns. The 512-dimensional embedding size may provide sufficient semantic information for accurate search while remaining compact enough for efficient storage and comparison operations on edge devices. This size strikes a balance between richness and efficiency. In particular, this size is large enough to preserve sufficient semantic information for accurate tasks like video search or similarity matching, while remaining small enough to enable fast comparison and low storage overhead in resource‑constrained edge environments. It should be noted that the above-discussed parameter values of the visual embeddings are just examples, and such values may vary from implementation to implementation.

In some embodiments, the generating module 402 may use an attention‑based vision model with a class token mechanism to create a single, compact visual embedding that represents the semantic meaning of an entire visual frame. In this approach, when a video frame or image is received, the generating module 402 first divides the image into smaller regions, such as 16×16 pixel patches. Each of these patches is converted into a feature vector that captures local visual information like texture, color, or edges. Along with these patch embeddings, a special learnable class token is added to the sequence. Through an attention mechanism, the class token interacts with and “attends to” all patch embeddings, allowing it to selectively aggregate information from across the entire image. For example, if a frame shows a person riding a bicycle on a road, some patches may represent the bicycle, others the person, and others the background. The attention mechanism enables the class token to combine these distributed cues into a unified understanding of the scene. After processing through the attention layers, the final state of the class token becomes a single 512‑dimensional vector that summarizes the semantic essence of the entire frame. This compact representation can then be efficiently stored, compared, or searched on the edge device while still preserving the most important visual meaning of the original image.

In some embodiments, the generating module 402 includes a feature extractor that first processes incoming video data to obtain visual feature data. The visual feature data may capture low‑level and mid‑level visual patterns such as edges, shapes, and object textures. In one example, a video frame captured by a camera on an edge device showing a person entering a room may be passed through a pre‑trained convolutional or vision transformer-based feature extractor whose parameters remain fixed during operation. Because the parameters are pre‑trained and not updated, the feature extractor provides stable and consistent feature representations without additional computational cost for training on the edge device. The generating module 402 may then apply an embedding transformation to these extracted features, mapping them from the original feature space into a different embedding space that is semantically meaningful and aligned with textual query data. For instance, the visual features corresponding to a “person,” “door,” and “indoor scene” may be transformed into a fixed‑dimensional visual embedding that lies close, in the embedding space, to textual embeddings generated from queries such as “a person entering a room.” This embedding space alignment allows visual embeddings and text embeddings to be directly compared using similarity measures. As a result, the generating module 402 produces visual embeddings of fixed dimensionality that are compact, semantically rich, and suitable for efficient cross‑modal search and retrieval on resource‑constrained edge devices.

In some embodiments, the generating module 402 may comprise an adapter module that may be configured to transform visual feature vectors into visual embeddings suitable for downstream semantic comparison. The visual feature vectors may be produced by a vision model and may have a relatively high dimensionality, for example, 2048 dimensions. The adapter module may include multiple fully connected layers with non‑linear activation functions that may progressively map these input visual feature vectors from their original dimensionality to a target embedding dimensionality, such as a 512‑dimensional embedding space that may be shared with or aligned to a textual embedding space. For instance, a visual feature vector extracted from an image depicting a red car parked on a street may be transformed by the adapter module into a 512‑dimensional visual embedding that may capture the semantic meaning of the scene and may be comparable to a text embedding generated from a query such as “red car on the road.”

Training of the adapter module may be performed using a contrastive learning approach. In such an approach, a training objective may minimize the distance between embeddings of matching visual-text pairs while maximizing the distance between embeddings of non‑matching pairs. During training, batches of image-text pairs may be processed, where images may be passed through the vision model and the adapter module, and textual data may be processed using a text encoder. The resulting visual and textual embeddings may be used to compute a contrastive loss that may guide optimization of the adapter module parameters. Additionally, in some embodiments, the adapter module may apply domain‑specific normalization techniques to account for variations in lighting conditions, image quality, camera sensors, or other environmental factors, which may help ensure that the generated visual embeddings remain consistent and robust across different capture scenarios.

In some example embodiments, embedding generation for a single video frame may require approximately 100-200 milliseconds when executed on commercially available mid‑range edge hardware, which may enable near real‑time processing at a sampling rate of about one to two frames per second. In other embodiments, depending on available computational resources and the number of camera streams being processed, the embedding generation rate may range from approximately 0.1 frame per second (1 frame every 10 seconds) to approximately 30 frames per second. The frame sampling rate may be adjusted dynamically based on operational conditions such as vehicle speed, processing load, available power, or application-specific requirements. In further embodiments, the embedding generation rate, input frame resolution, or embedding dimensionality may be increased beyond the values described herein as edge computing hardware capabilities advance over time. For example, an edge device deployed in a retail store or office environment may periodically sample video frames from a connected camera and generate visual embeddings without introducing significant latency or overloading device resources. The generating module 402 may also be configured to receive update information related to the embedding transformation, and based on this update information, the generating module 402 may update the embedding transformation locally on the edge device. Such updates may gradually improve semantic alignment between visual embeddings and text embeddings, for instance, by enabling more accurate matching between video content and user search queries over time. In some embodiments, the adapter module may be updated or fine‑tuned based on feedback indicating search result accuracy, such as whether retrieved video segments were relevant to user queries. Additionally, in certain embodiments, the adapter module may be selected from a plurality of available adapter modules based on characteristics of the edge device, including processing capability, camera sensor properties, or the specific deployment environment, thereby allowing the system to balance performance, accuracy, and resource constraints across different edge installations.

In some embodiments, the generating module 402 may apply privacy processing to video data captured by a camera associated with an edge device before generating one or more visual embeddings. This privacy processing may include identifying and obscuring privacy‑sensitive visual elements present in the video data, such as human faces, license plates, or other identifying markings. For example, if a camera captures video of individuals walking through a parking area, the generating module 402 may detect faces and blur them to prevent individual identification, while also obscuring license plate information to protect vehicle identities. Other forms of personally identifiable information that may appear in the visual field, such as badges or signage with names, may likewise be removed or masked. The visual embeddings may then be generated from the privacy‑processed video data rather than from the raw footage. In some embodiments, the resulting embeddings may not allow reconstruction of the obscured or removed visual elements, as the embedding generation pipeline may employ algorithms that structurally prevent recovery of privacy‑sensitive information. A portion of this pipeline may be implemented as a one‑way transformation that makes it computationally infeasible to reverse‑engineer the original visual content. For example, prior to processing an image with a neural network to extract visual features, a gaussian-blur or other spatial low-pass filter may be applied to regions of the image containing privacy-sensitive information, such as faces or license plates, thereby ensuring that personal or identifying details are not represented in any embeddings subsequently computed, stored, transmitted, or compared for search and analysis purposes. In other embodiments, the spatial low-pass filter or other information-destroying transformation may be applied to the entire image or to image regions identified by other criteria.

In some embodiments, the generating module 402 may associate geolocation data with each of the one or more visual embeddings generated from the video data. The geolocation data may indicate the physical location at which the corresponding video frame or segment was captured by the edge device. For example, an edge device deployed at the entrance of a warehouse or in a public parking area may generate visual embeddings for captured video frames and may tag each embedding with latitude and longitude information. The geolocation data may be obtained from a Global Positioning System (GPS) module associated with the edge device, or from another location‑determination component integrated with the device. By associating location information with the visual embeddings, the system may enable location‑aware search, filtering, or analysis, such as retrieving embeddings corresponding to a specific site, geographic region, or deployment location, while still operating on compact, privacy‑preserving representations rather than raw video data.

In some embodiments, the generating module 402 may generate one or more audio embeddings from audio data captured by a microphone associated with the edge device. The audio data may include sounds such as speech, environmental noise, alarms, or vehicle sounds occurring near the edge device. The generating module 402 may process this audio data using an audio feature extractor and transform the extracted features into fixed‑dimensional audio embeddings. In some embodiments, these audio embeddings may be generated in the same embedding space as the visual embeddings, which may enable direct comparison and correlation across different modalities. For example, an audio embedding representing the sound of a car horn may be closely aligned in the embedding space with a visual embedding generated from video frames showing vehicles in motion. This shared embedding space may allow the system to support multimodal search and analysis, such as retrieving video segments based on an audio‑based query or combining audio and visual signals to improve event detection and semantic understanding at the edge.

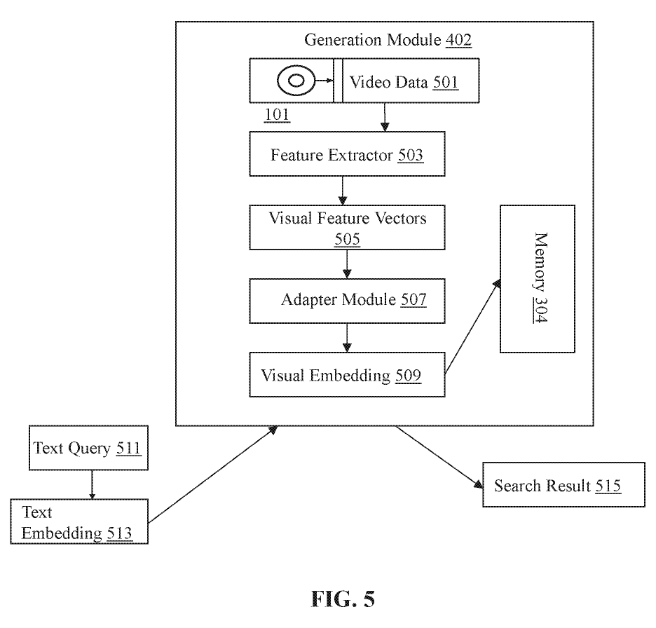

In an embodiment, the working of the generation module 402 has been further explained in detail in reference to FIG. 5.

In some embodiments, the transceiver module 404 may be configured to manage communication between the edge device and one or more external systems, such as a remote server or cloud‑based platform. The transceiver module 404 may receive a query embedding from the server, where the query embedding may correspond to a search query 105 initiated by a user or an automated application. The search query 105 may include a textual description of visual content to be located, such as “a person entering a restricted area,” an image‑based query derived from a reference image, or a combination of textual query data and visual query data. For example, a server may generate a query embedding from a text description and transmit it to the edge device, and the transceiver module 404 may then forward this query embedding to local processing components for comparison with stored visual or audio embeddings. In addition, the transceiver module 404 may facilitate the transmission and reception of search results, intermediate comparison data, and other information required to support distributed search operations across multiple edge devices. In some embodiments, the transceiver module 404 may also receive update information for the embedding transformation from the server, and may provide this update information to the generating module 402, allowing the edge device to adapt and improve embedding alignment or search accuracy over time without requiring full system redeployment.

In some embodiments, the identifying module 406 may be configured to identify one or more matching visual embeddings from among the visual embeddings retained at the edge device by comparing a received query embedding with the stored embeddings. The query embedding may represent a search request, such as a textual description, an image‑based query, or a multimodal query, and the identifying module 406 may evaluate how closely this query embedding matches each stored visual embedding. In some embodiments, the identification process may comprise calculating a similarity score between the query embedding and each visual embedding using similarity metrics such as cosine similarity or Euclidean distance. For example, a query embedding corresponding to “a person wearing a helmet” may be compared against thousands of stored visual embeddings generated from past video frames, and higher similarity scores may indicate stronger semantic matches. The identifying module 406 may then determine whether a similarity score exceeds a predefined similarity threshold and, based on this determination, may identify one or more visual embeddings as matching embeddings. Because the comparison operations work on compact fixed‑dimensional vectors rather than raw video data, each comparison may require less than approximately, for example, 50 microseconds, which may enable rapid search across thousands of embeddings stored locally on the edge device and support low‑latency, real‑time search and retrieval.

In some embodiments, the identifying module 406 may be configured to map the identified matching visual embeddings back to their corresponding video frames retained at the edge device. For example, after comparing a query embedding with stored visual embeddings and selecting those that exceed a similarity threshold, the identifying module 406 may determine which specific frames or time segments of the recorded video generated those embeddings. This association may allow the system to retrieve or reference precise video frames that semantically match the search query 105 without scanning raw video streams. In addition, in some embodiments, the identifying module 406 may perform a similar comparison process for audio data by comparing the query embedding with one or more audio embeddings retained at the edge device. By calculating similarity scores between the query embedding and the stored audio embeddings, the identifying module 406 may identify one or more matching audio embeddings that correspond to relevant sound events, such as speech, alarms, or environmental noises. This multimodal identification capability may enable the system to locate relevant video frames, audio segments, or combined audiovisual events based on a single query embedding, thereby improving search flexibility and semantic accuracy at the edge.

In some embodiments, the determining module 408 may be configured to determine and manage parameters and strategies associated with the search process executed at the edge device. The determining module 408 may dynamically adjust the similarity threshold used to identify matching embeddings based on the computational resources currently available, such as processor load, memory utilization, or power constraints. For example, when the edge device is operating under limited resources or high system load, the determining module 408 may increase the similarity threshold to reduce the number of candidate matches and conserve processing capacity, thereby prioritizing precision over recall. Conversely, when sufficient resources are available, the determining module 408 may lower the similarity threshold to allow a broader set of potential matches to be identified, potentially improving search coverage. In such embodiments, determining whether a similarity score exceeds the similarity threshold may comprise comparing the score against the dynamically adjusted threshold rather than a fixed value. This adaptive behavior may enable the edge device to balance search accuracy, responsiveness, and resource efficiency, allowing robust search performance across varying operational conditions.

In some embodiments, the determining module 408 may be configured to evaluate an authorization level associated with a search query 105 corresponding to a received query embedding. The authorization level may indicate the permissions or access rights of the entity initiating the search and may govern what types of visual content are eligible to be included in the search results, as well as the level of detail at which those results may be presented. For example, a user with elevated authorization may be permitted to receive full video frame references, while a user with limited authorization may only receive high‑level metadata or abstracted indicators of matching content. In addition, the determining module 408 may determine a confidence score for each of the identified one or more video frames. The confidence score may represent a degree of similarity between the query embedding and the corresponding visual embedding and may be derived directly from the calculated similarity score. This confidence score may be used to rank search results, filter out low‑relevance matches, or provide an indication of result reliability to downstream systems or users, thereby enabling more controlled, secure, and interpretable search outcomes at the edge device.

In some embodiments, the applying module 410 may be configured to apply various processing operations as part of the search workflow after relevant video frames have been identified. The applying module 410 may apply a privacy filter to the identified one or more video frames based on the authorization level determined for the search query 105 before any information associated with those video frames is transmitted to a server. The privacy filter may control which categories of content are permitted to appear in the search results. For example, when a search query 105 is associated with a basic authorization level, the applying module 410 may restrict the results to exclude detections involving people, faces, or vehicles, and may instead limit the output to non‑sensitive content such as infrastructure elements, environmental conditions, or object presence indicators. In some embodiments, the privacy filters may also regulate the level of detail included in the results, such as providing only metadata, timestamps, or confidence scores rather than visual thumbnails or frame data when the authorization level does not permit access to detailed visual content. This conditional application of privacy controls may help ensure that sensitive information is protected while still allowing useful search functionality to be delivered in accordance with access policies and privacy requirements.

In some embodiments, the selecting module 412 may be configured to choose relevant search results or content based on one or more defined selection criteria. For example, when information associated with identified video frames is to be transmitted to a server, the selecting module 412 may first evaluate confidence scores assigned to those video frames and may select only those video frames whose confidence scores exceed a predefined threshold. This approach may help ensure that only highly relevant or reliable matches are included in the transmitted results. In some embodiments, the selecting module 412 may transmit the selected one or more video frames, or information associated with those frames, to the server for further processing, presentation, or aggregation with results from other edge devices. The selecting module 412 may also filter or rank search results based on additional parameters, such as ranking scores, relevance metrics, temporal constraints, or policy‑defined limits, thereby enabling controlled and efficient result delivery while reducing unnecessary data transmission and focusing on the most meaningful search outcomes.

In some embodiments, after the selecting module 412 selects one or more matching video frames, the transceiver module 404 may transmit information associated with the identified video frames to a server. The transmitted information may vary depending on system configuration, network conditions, and available bandwidth. For example, in bandwidth‑constrained scenarios, the transceiver module 404 may transmit only lightweight metadata such as timestamps indicating when the matching frames were captured, geolocation data identifying where the capture occurred, and confidence scores reflecting the relevance of each match. In other embodiments, where additional detail is permitted and sufficient bandwidth is available, the transmitted information may include preview images of the matching frames or short video segments containing the detected events. The server may receive similar responses from multiple edge devices deployed at different locations and may aggregate these responses to generate consolidated search results, rank matches across devices, or provide a unified view of relevant events, while minimizing unnecessary transmission of raw video data.

In some embodiments, the modular architecture of the searching apparatus may enable efficient processing of visual data and search queries while preserving the distributed nature of the overall search system. The searching apparatus may be configured to generate visual embeddings from video frames captured at the edge, store those embeddings locally in accordance with defined retention policies, and operate without the need to continuously transmit raw video data to a central system. The searching apparatus may further receive query embeddings from a server and compare the received query embeddings with the locally stored visual embeddings to identify potential matches. Based on the comparison results, the searching apparatus may determine which video frames correspond to the matching embeddings and may transmit information associated with those video frames, such as metadata or selected content, back to the server. The server may then aggregate results received from multiple edge devices to produce consolidated search outputs. This modular and distributed configuration may allow the system to scale efficiently, reduce bandwidth usage, and support low‑latency search operations while maintaining flexibility in deployment and processing at the edge.

FIG. 5 illustrates a block diagram of the generation module 402, in accordance with an embodiment of the present disclosure. As shown, the generating module 402 may receive the captured video data 501 from the camera 101A. The video data may represent scenes or activities occurring within the camera’s field of view. For example, the camera 101 may record a video stream of a building entrance where people are moving in and out throughout the day. The captured video data 501 may then be provided to the feature extractor 503. The feature extractor 503 may analyze the raw pixel data to extract meaningful visual information. The feature extractor 503 may process each video frame to generate visual feature vectors 505 that encode visual patterns such as shapes, edges, object structures, and spatial relationships in a high‑dimensional feature space suitable for computer vision tasks. In some embodiments, the feature extractor 503 may comprise a pre‑trained neural network originally trained for generic vision tasks such as object recognition or image classification, rather than being specifically optimized for semantic search. For instance, the feature extractor 503 may recognize contours corresponding to people, doors, or vehicles in the scene without explicitly labeling them for search purposes. The feature extractor 503 may process the video data 501 using fixed, pre‑trained parameters that remain unchanged during operation, thereby providing stable and consistent visual feature vectors 505 that can be reused for downstream processing such as embedding generation and search, without requiring additional training or fine‑tuning during runtime.

The visual feature vectors 505 generated by the feature extractor 503 may be provided to the adapter module 507 for further processing. The adapter module 507 may be configured to transform the visual feature vectors 505 into visual embeddings 509 that are suitable for search and comparison. For example, if the feature extractor 503 generates a feature vector corresponding to a scene containing a vehicle near a building entrance, the adapter module 507 may convert that feature vector into a compact visual embedding that captures the semantic meaning of the scene. The adapter module 507 may act as a bridge between the output of the feature extractor 503 and text‑based search capabilities by converting the visual feature vectors 505 into a representation that is compatible with text embeddings derived from natural‑language queries. In this manner, a text query such as “vehicle near an entrance” may be directly compared with the visual embeddings 509. The visual embeddings 509 may be stored in a memory 304 to support subsequent search operations without requiring reprocessing of the original visual data.

In some embodiments, the adapter module 507 may apply an embedding transformation to the visual feature vectors 505 to generate visual embeddings 509 that are suitable for semantic search. The visual embeddings 509 may have a fixed dimensionality and may reside in an embedding space that is aligned with textual query data. This embedding space may be different from the feature space used by the feature extractor 503. For example, the feature extractor 503 may generate a 2048‑dimensional visual feature vector representing a scene that includes a person standing near a doorway. The adapter module 507 may progressively transform this 2048‑dimensional vector into a 512‑dimensional visual embedding that fits within a standardized text embedding space. During this transformation, the adapter module 507 may preserve the semantic meaning of the scene, such as the presence of a person and the location context. As a result, the generated 512‑dimensional visual embedding may be directly comparable with a text embedding generated from a query such as “person near an entrance,” enabling efficient cross‑modal search and matching.

The visual embeddings 509 may be stored in a highly optimized memory structure that is designed to support fast similarity search operations. For example, if hundreds or thousands of visual embeddings are generated from video frames captured over time, these embeddings may be placed in contiguous memory regions rather than being scattered across files or a conventional database. This organization may allow the system to access multiple embeddings quickly during a search operation. When a text query embedding is compared against the stored visual embeddings 509, the contiguous storage may enable rapid batch comparisons instead of individual lookups. As a result, the time required to identify matching visual content may be significantly reduced. This pre‑organized memory structure may therefore improve overall search efficiency, especially when large numbers of embeddings are evaluated frequently.

In some embodiments, search operations may be implemented using GPU acceleration to improve comparison speed. For example, when a query embedding is compared against a large number of stored visual embeddings, the system may use custom GPU kernels to perform similarity calculations. These custom kernels may enable each comparison operation to complete in microseconds rather than milliseconds. The GPU‑accelerated approach may use techniques similar to those found in established similarity search libraries, but may be adapted to fit the illustrated system architecture. By leveraging GPU parallelism, the system may compare many embedding vectors at the same time instead of sequentially. This parallel execution may enable search speeds that are not achievable with conventional CPU‑based processing. As a result, overall search efficiency may be significantly improved, especially when handling large embedding collections.

The generating module 402 may support flexible embedding generation rates that may range from approximately 1 frame per second to approximately 30 frames per second, depending on available computational resources and system workload. For example, in a low‑activity scenario where limited processing resources are available, the generating module 402 may generate embeddings at a lower rate, such as one frame per second, to conserve compute capacity. In contrast, when sufficient resources are available and multiple camera streams are actively monitored, the generating module 402 may increase the embedding generation rate to capture more visual detail, such as processing up to 30 frames per second. The embedding generation frequency may be dynamically adjusted in response to changes in processing load, resource availability, or application requirements. This dynamic adjustment may allow the system to balance responsiveness and accuracy with efficient use of computational resources.

In some embodiments, the generating module 402 may support clip‑based embeddings that represent short temporal segments of video instead of individual frames. For example, a clip‑based embedding may be generated from several consecutive frames showing a person walking across a hallway. By aggregating visual information across these frames, the clip‑based embedding may capture motion patterns, temporal context, and event sequences that would not be evident from a single still frame. This may improve search accuracy for events that unfold over time, such as entering, exiting, or interacting actions.

The unified visual search framework may also support region‑based embeddings that focus on specific areas of interest within video frames. For example, instead of analyzing an entire frame, a region‑based embedding may be generated only from a doorway area or a section containing a vehicle. This targeted approach may allow a more precise search for objects or features that occupy only a portion of the visual field. By concentrating on smaller or localized visual elements, region‑based embeddings may improve detection and retrieval accuracy.

In some embodiments, the unified visual search framework may further support sliding window approaches for embedding generation. A sliding window approach may process overlapping temporal segments of video rather than fixed, non‑overlapping clips. For example, the system may generate embeddings from video segments that overlap by a few frames to ensure that visual events occurring near segment boundaries are not missed. This approach may balance visual coverage and computational efficiency by capturing relevant events while limiting unnecessary processing load.

In some embodiments, the generating module 402 may receive a search query, such as search query 511, from an external source, such as a user. For example, a user may submit a text search query 105 like “person entering a room.” The generating module 402 may convert the search query 105 into a query embedding 513. The query embedding 513 may be generated in the same embedding space as the visual embeddings 509 stored in the memory 304. The generating module 402 may then receive the query embedding 513 and may access the stored visual embeddings 509. The generating module 402 may compare the query embedding 513 with the visual embeddings 509 to identify semantically similar visual content. For instance, embeddings generated from video frames showing a person walking through a doorway may produce high similarity scores. Based on this comparison, the generating module 402 may generate a search result 515 that identifies the relevant video frames or video segments corresponding to the search query 511.

In some embodiments, open‑vocabulary search across captured visual data may be enabled. This capability may allow users to search for arbitrary concepts expressed in natural language without relying on predefined object classes or scene categories. For example, a user may submit a query such as “a person leaving through a side door” or “a vehicle stopping near a barrier,” even if these concepts were not explicitly defined during system configuration. The system may interpret the natural‑language query by converting it into a query embedding and comparing it with stored visual embeddings. As a result, relevant video frames or segments may be identified based on semantic similarity rather than fixed labels. This flexible search approach may allow users to explore visual data using descriptive language that matches real‑world intent, improving usability and adaptability across different applications and scenarios.

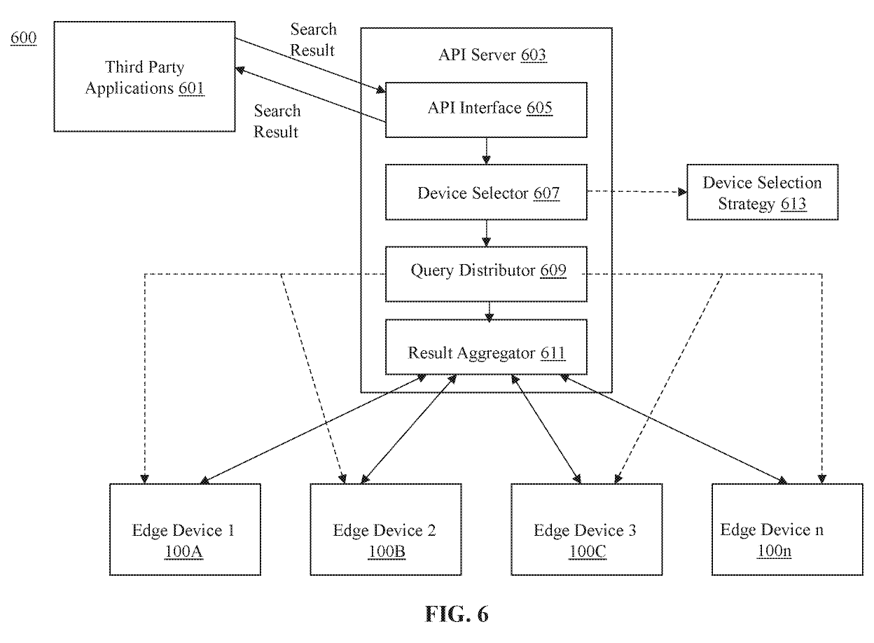

FIG. 6 illustrates a block diagram of a system 600 for enabling third-party applications to search distributed visual data, in accordance with an embodiment of the present disclosure. The system 600 includes one or more third‑party applications 601, an Application Programming Interface (API) server 603, and a plurality of edge devices, including an edge device 1 100A, an edge device 2 100B, an edge device 3 100C, and an edge device n 100n. As shown, the one or more third‑party applications 601 may initiate search requests, such as natural‑language queries or image‑based queries, to locate relevant visual content. These requests may be sent to the API server 603, which may act as an interface between the one or more third‑party applications 601 and the plurality of edge devices, including edge device 100A, edge device 100B, edge device 100C, and edge device 100n. The API server 603 may receive the search requests, convert them into query embeddings or other standardized formats, and distribute the queries to the appropriate edge devices. For example, if a third‑party application requests video segments related to “vehicles entering a parking area,” the API server 603 may forward the corresponding query to multiple edge devices that monitor different parking locations. Each edge device may perform local search operations on its stored visual data and return matching results to the API server 603. The API server 603 may then aggregate the results received from the plurality of edge devices and provide consolidated search results back to the third‑party applications 601, enabling efficient and scalable search across distributed visual data sources.

In some embodiments, the third‑party applications 601 may communicate with the API server 603 to submit search queries and receive corresponding search results. For example, a third‑party security application may send a natural‑language query such as “person entering a restricted area” to the API server 603. The API server 603 may include multiple components that facilitate the handling and execution of such search requests. An API interface 605 may be responsible for receiving search requests from the third‑party applications 601 and delivering search results back to those applications. The API interface 605 may provide standardized endpoints that allow third‑party applications 601 to submit new search requests, check the status of ongoing or completed searches, and retrieve search results. In addition, the API interface 605 may manage device access permissions to ensure that third‑party applications are authorized to query specific data sources. The API interface 605 may also support access to usage analytics, enabling third‑party applications 601 or administrators to monitor query activity, system usage, and performance characteristics.

In some embodiments, the system 600 may include a device selector 607. The device selector 607 may be configured to determine which edge devices should receive a particular search query 105. For example, when a search query 105 such as “vehicle entering a parking area last night” is received, the device selector 607 may work together with a device selection strategy 613 to decide where the query should be sent. The device selection strategy 613 may define criteria such as geographic proximity, so that only devices located near the specified parking area are selected. The strategy 613 may also apply temporal criteria, for instance, by selecting only those devices that were active during the time window referenced in the query. In addition, the device selection strategy 613 may consider device capabilities, such as whether a device has suitable cameras or sufficient processing power to handle the query. In some embodiments, the device selector 607 may also use historical detection patterns, for example, by prioritizing devices that previously captured video of vehicles in similar contexts. By directing queries to edge devices with a higher likelihood of containing relevant visual data, the device selector 607 may improve overall search efficiency and reduce unnecessary processing across the distributed system.

In some embodiments, the system 600 may include a query distributor 609. The query distributor 609 may be responsible for managing the transmission of search requests to selected edge devices. For example, after a device selector determines that edge device 100A, edge device 100B, and edge device 100C are relevant for a search query 105 such as “car entering a parking area,” the query distributor 609 may forward the search request to those devices. The query distributor 609 may distribute the query based on the selection made by the device selector 607, ensuring that only relevant devices receive the request. In some embodiments, the query distribution may be prioritized so that devices most likely to contain matching visual content process the query first. This prioritization may reduce overall response time. The query distributor 609 may also transform the search parameters into a format suitable for processing at each edge device. For instance, the query distributor 609 may generate a query embedding from a text search query 105 and transmit the query embedding to the selected devices, allowing direct comparison with visual embeddings stored locally on those devices.

In some embodiments, the system 600 may include a result aggregator 611. The result aggregator 611 may be configured to receive result data returned from multiple edge devices and combine the individual responses into unified search results. For example, edge device 100A, edge device 100B, and edge device 100C may each return information about video frames that match a search query 105, such as “vehicle near an entrance.” The result aggregator 611 may collect this information and process it together to generate an aggregated view of all relevant matches. The aggregated search results may then be provided to third‑party applications 601 through the API interface 605. In some embodiments, the result aggregator 611 may filter incoming results based on relevance or confidence scores, so that low‑confidence matches that may represent false positives are removed. The result aggregator 611 may also identify and remove duplicate detections, for example, when the same vehicle is captured by multiple edge devices from different viewing angles. Additionally, the result aggregator 611 may format the aggregated results according to parameters specified in the original search request, such as returning summaries, metadata, or preview content, ensuring that the third‑party applications 601 receive results in an expected and consistent format.

In some embodiments, the API server 603 may include a developer sandbox environment that allows developers to test search queries before deploying applications in a production setting. For example, a developer creating a third‑party application for searching visual events may use the sandbox environment to submit sample queries such as “person entering a building” or “vehicle stopping near a gate.” The sandbox may execute these queries against sample or test visual data and return example search results. This environment may help developers observe how query embeddings are generated, how results are ranked, and how different parameters affect search outcomes. By experimenting within the sandbox, developers may adjust query phrasing, time ranges, or filtering options to improve accuracy and performance. As a result, the developer sandbox environment may help developers better understand system behavior and optimize their applications before deploying them in live or production environments.

In some embodiments, the API server 603 may provide feedback to the third‑party applications 601 to help optimize search requests. For example, after a third‑party application submits multiple search queries such as “person near entrance” or “vehicle at gate,” the API server 603 may analyze the queries and the resulting matches. The API server 603 may then provide feedback indicating how specific query terms, time ranges, or filters affected result quality and processing efficiency. This feedback may show, for instance, that overly broad queries return many low‑confidence matches or increase processing time. By reviewing this feedback, developers may refine query formulations to be more precise, improve the relevance of search results, and reduce unnecessary computational overhead. As a result, the feedback mechanism may help third‑party applications achieve better performance and more accurate outcomes when searching distributed visual data.

Accordingly, the system 600 may enable one or more third‑party applications 601 to leverage distributed visual search capabilities while abstracting the underlying complexity of device management, query routing, and result aggregation. For example, a third‑party application may submit a high‑level search request without needing to know which edge devices store relevant visual data, how queries are dispatched, or how partial results are combined. The system 600 may handle these operations internally, allowing the third‑party applications 601 to focus on application logic and user experience rather than infrastructure details.

In an example implementation, a retail analytics application may use the system 600 to analyze brand visibility across urban areas. The retail analytics application may submit search queries for specific brand logos or storefront designs through the API interface 605. Based on the device selection strategy 613, the device selector 607 may identify edge devices installed in delivery vehicles that operate within targeted geographic regions. The query distributor 609 may distribute the search queries to the identified edge devices. Each edge device may search stored visual embeddings to identify instances where the specified brand logos or storefronts appear. The edge devices may return metadata such as geographic location and timestamp for each detection. The result aggregator 611 may aggregate this information over time, enabling the retail analytics application to generate heat maps that show areas of high brand visibility. In some embodiments, the system 600 may quantify visual footprint as “brand impressions” by counting how often brand logos appear in captured visual data. The system 600 may also generate geographic distribution maps indicating where particular brands have the strongest presence. Additionally, the system 600 may help measure return on investment for fleet branding by treating branded vehicles as moving billboards and tracking how frequently those vehicles are visible across different locations, all without requiring access to raw video footage.

In another example implementation, an infrastructure monitoring application may use the system 600 to identify and analyze conditions such as road surface quality, traffic sign placement, or construction activity across a geographic region. The infrastructure monitoring application may submit search queries describing infrastructure elements of interest, such as “damaged road surface” or “temporary construction barriers.” The device selector 607 may select edge devices based on proximity to the specified locations and temporal criteria related to recent observations. The selected edge devices may perform local searches and return detected matches. The result aggregator 611 may then combine results from multiple edge devices to provide a consolidated and up‑to‑date view of infrastructure conditions across the monitored region, enabling more informed planning and maintenance decisions.

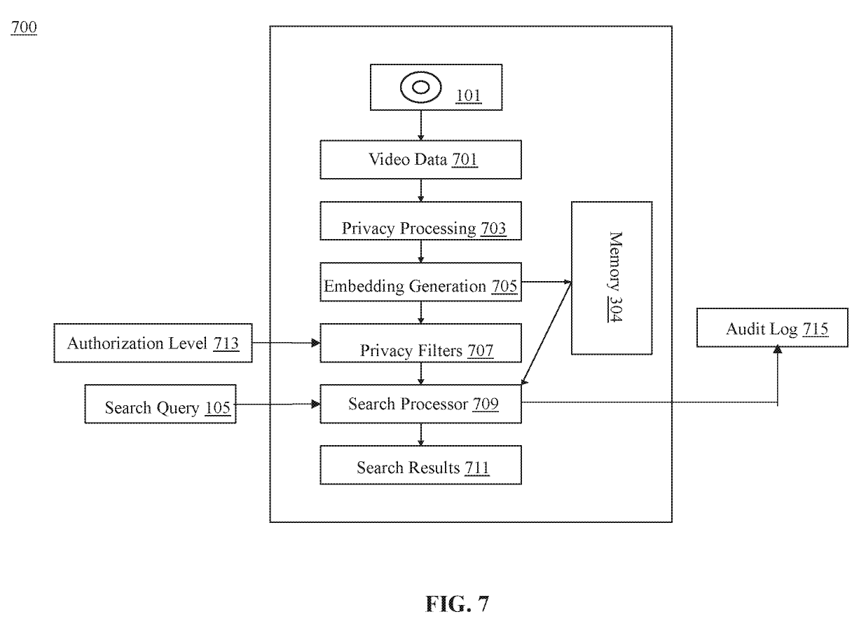

FIG. 7 illustrates a workflow 700 for privacy-preserving search of visual data at the edge device 100A, in accordance with an embodiment of the present disclosure.

As shown, the one or more cameras 101 (also referred to as cameras 101) capture video data 701 from their surrounding environment. For example, the camera 101 may record a video stream of a public street where pedestrians and vehicles pass by. Before this video data 701 is used for further analysis, the video data 701 may be forwarded to a privacy processing component 703. The privacy processing 703 may apply privacy‑related transformations to the video data 701, such as detecting and blurring faces of individuals to prevent personal identification. In another example, if vehicles are present in the scene, the privacy processing 703 may obscure license plate numbers to protect vehicle identities. The privacy processing 703 may also remove or mask other forms of personally identifiable information that may appear in the captured footage. By applying the privacy processing 703 before generating visual embeddings, the edge device 100A may help ensure that sensitive visual details are not encoded into the embeddings. As a result, the visual embeddings used for search operations may represent semantic information about the scene, such as the presence of people or vehicles, without exposing privacy‑sensitive data.

In some embodiments, after the privacy processing 703 is applied, the privacy‑processed video data 701 may be forwarded to an embedding generation component 705. The embedding generation component 705 may generate visual embeddings that represent the semantic content of the video while excluding privacy‑sensitive details. For example, if the original video captured people walking through a public space, the faces may already be blurred by the privacy processing 703, and the embedding generation component 705 may then generate embeddings that capture activities such as “people walking” or “crowded area” without encoding identifiable facial features. The embedding generation component 705 may interact with a memory 304 to store the generated visual embeddings for later use. The memory 304 may store these embeddings in a highly optimized memory structure that is designed for fast similarity search operations. As a result, when a search query 105 is later received, the system may quickly compare the query embedding with the stored visual embeddings to identify relevant matches, without reprocessing the underlying video data or exposing raw, privacy‑sensitive content.

In some embodiments, the edge device 100A may apply privacy processing to video data 701 before any visual embeddings are generated. For example, if the camera captures video of a public area where people and vehicles are present, the privacy processing may first detect and blur faces, obscure license plates, and mask other privacy‑sensitive visual elements in the video data 701. After this privacy processing, the edge device 100 may generate one or more visual embeddings from the modified video data. These visual embeddings may represent semantic aspects of the scene, such as movement patterns or object presence, without encoding identifiable details. In some embodiments, the embedding generation component 705 may use algorithms that are designed as one‑way transformations, meaning that the privacy‑sensitive visual elements removed or obscured earlier cannot be reconstructed from the resulting visual embeddings. As a result, even if the visual embeddings are accessed or analyzed later, it may be computationally infeasible to reverse‑engineer the original video content or recover personal identifying information, thereby preserving privacy while still supporting effective search and analysis.

In some embodiments, the edge device 100A may receive a search query 105 along with an associated authorization level 713 from one or more external sources. For example, a user may submit a search query 105 such as “people near an entrance,” along with login credentials or an application identifier. The authorization level 713 may define the scope of access permitted for that search operation. In some cases, the authorization level 713 may be determined based on the identity or role of the user submitting the search query 105, such as whether the user is an administrator or a standard user. In other cases, the authorization level 713 may be determined based on a declared purpose of the search, such as analytics, security monitoring, or compliance auditing. Based on the authorization level 713, the edge device 100A may later control what types of visual content can be searched, how detailed the results may be, or whether certain privacy‑sensitive information must remain filtered or abstracted in the search results.

In some embodiments, privacy filters 707 may be applied based on the authorization level 713 to control both the type of visual content that can appear in search results and the level of detail that can be disclosed. For example, when a user submits a search query 105 with a basic authorization level, the privacy filters 707 may limit the results to non‑sensitive content such as infrastructure elements, weather conditions, or general scene descriptions. In this case, detections involving people or vehicles may be excluded from the results. If a search query 105 relates to activity near a building entrance, the system may return metadata indicating the presence of movement or usage patterns rather than images or clips showing individuals. In addition, the privacy filters 707 may regulate the level of detail provided in the results. For users with insufficient authorization, the system may return only high‑level metadata such as timestamps, locations, or confidence scores instead of visual frames or video segments. This selective filtering may help ensure that sensitive visual information is protected while still allowing meaningful insights to be derived in accordance with the user’s authorization level.

In some embodiments, a search processor 709 may receive input from the privacy filters 707 and may access the memory 304 to perform search operations. For example, when a user submits a search query 105 such as “activity near an entrance,” the privacy filters 707 may first determine what type of content can be considered based on the user’s authorization level 713. The search processor 709 may then compare the query embedding with the visual embeddings stored in the memory 304 while respecting those privacy constraints. Based on this comparison, the search processor 709 may identify matching visual content and generate search results 711 that align with the permitted level of access. For users with minimal authorization, the search results 711 may include only anonymized metadata, such as the number of matching instances, approximate locations, or statistical summaries. For users with intermediate authorization, the search processor 709 may provide anonymized visual results in which sensitive elements, such as faces or license plates, are obscured while still preserving contextual details relevant to the search query 105.

In some embodiments, the edge device 100A may apply differential privacy techniques to the outputs generated from search operations in order to enhance privacy protection. For example, when the system generates aggregated statistics such as the number of times a particular activity occurred in a location, the system may introduce a controlled amount of statistical noise into the results. This added noise may be calibrated so that overall trends, such as increases or decreases in activity, remain visible while details about specific individuals or isolated events cannot be inferred. In this manner, even if a search result reports counts, averages, or frequency patterns, the differential privacy techniques may prevent an observer from determining whether a particular person or event was included in the underlying data. As a result, the edge device 100A may provide meaningful insights about general patterns and trends, such as traffic flow or crowd density over time, while reducing the risk that sensitive information about specific individuals or events can be derived from aggregated search results.

In some embodiments, the edge device 100A may implement time‑limited authorizations that automatically expire after a predetermined duration. For example, a user or application may be granted permission to perform search operations for a limited period, such as a few hours or a single work shift. Once this period expires, the authorization may no longer be valid, and the user may be required to reauthenticate or request renewed access before continuing to use the search functionality. This approach may help ensure that access permissions remain current and intentional rather than persisting indefinitely. By requiring periodic renewal of authorization, the edge device 100A may add a layer of security, reduce the risk of unauthorized or forgotten access, and ensure that permissions are regularly reviewed and aligned with current roles, responsibilities, or usage purposes.

In some embodiments, the edge device 100A may include provisions for handling emergency‑related criteria, such as those associated with Amber Alerts for missing children. For example, when a search query 105 includes emergency criteria indicating an active Amber Alert, the edge device 100A may first verify that the emergency request satisfies predefined verification requirements. This verification may involve checking whether the alert has been officially issued or confirmed by an authorized law enforcement or public safety authority. Upon successful verification, the edge device 100A may allow temporary modification of standard privacy restrictions that would otherwise limit searches involving specific individuals or vehicles. For instance, while searches for identifiable vehicles may typically be restricted, the edge device 100A may permit such searches during a verified Amber Alert to support emergency response efforts. This controlled relaxation of privacy constraints may ensure that emergency searches are conducted responsibly, remain limited to verified situations, and are only enabled when validated by appropriate authorities.

In some embodiments, metadata associated with the visual embeddings stored in the memory 304 may include anonymized location information instead of precise geographic coordinates. For example, when visual embeddings are generated from video captured in a densely populated urban area, the edge device 100A may reduce the precision of the associated location data from an exact street address or intersection to a broader area, such as a neighborhood or administrative district. This reduced‑precision location data may still indicate that an event occurred within a general region, which may be sufficient for search and analysis purposes, while limiting the ability to identify a specific building or address. In contrast, when visual embeddings are generated in sparsely populated or rural areas, the edge device 100A may retain relatively higher location precision without significantly increasing privacy risks. By dynamically adjusting the precision of location metadata based on population density, the edge device 100A may provide useful geographic context for search results while reducing the likelihood that the stored metadata could be used to infer specific locations or identify individuals in crowded environments.

In some embodiments, the edge device 100A may include an audit log 715 that is configured to maintain detailed records of search activities performed by the system. For example, when a user submits a search query 105 to locate specific visual content, information about the query, the associated authorization level, and the results provided may be recorded in the audit log 715. The audit log 715 may receive relevant data from the memory 304, such as metadata about accessed visual embeddings, as well as from the search processor 709, which may indicate how queries were evaluated and what results were returned. This comprehensive logging may enable full traceability of search operations for compliance and accountability purposes. In some embodiments, the audit log 715 may store records in an immutable format, meaning that once entries are written, they cannot be altered or deleted. This immutability may allow auditors or administrators to later verify that searches were conducted in accordance with privacy policies, regulatory requirements, or internal access controls, and may help ensure accountability for all access to visual data managed by the edge device 100A.

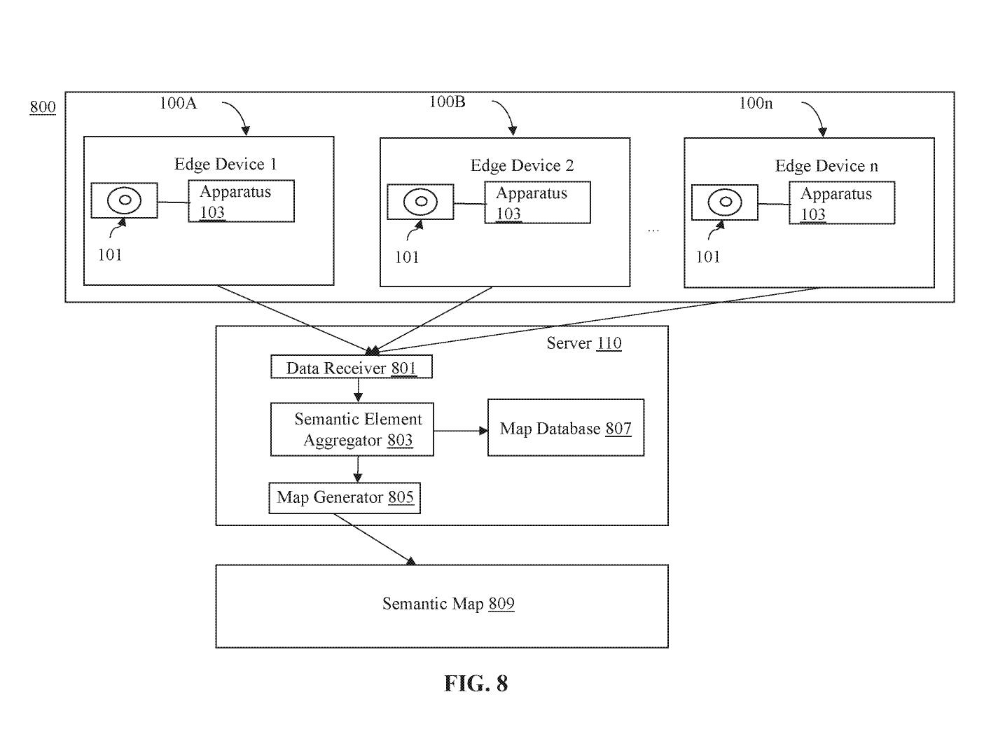

FIG. 8 illustrates a system for generating semantic maps using distributed edge devices, in accordance with an embodiment of the present disclosure. As shown, the system 800 may include a plurality of edge devices, shown as edge device 1 100A, edge device 2 100B, and edge device n 100n, each equipped with the one or more cameras 101 and the searching apparatus 103. The edge devices 100A, 100B, 100n capture video data of environments through their respective cameras 101 and process this data using the searching apparatus 103 to detect semantic elements and associate geolocation data with the detected elements.

The system 800 may further include the server 110 that receives semantic element data from the plurality of edge devices 100A, 100B, 100n. The server 110 comprises a data receiver 801 configured to receive the semantic element data with associated geolocation data transmitted from the edge devices 100A, 100B, 100n. The data receiver 801 forwards the received data to a semantic element aggregator 803, which aggregates the semantic element data from the multiple edge devices 100A, 100B, 100n. The semantic element aggregator 803 identifies multiple detections of the same semantic element from different edge devices or at different times and consolidates these detections to refine location accuracy.

The server 110 also includes a map generator 805 that receives the aggregated semantic element data from the semantic element aggregator 803 and generates a semantic map 809 based on this aggregated data. The map generator 805 assigns confidence scores to mapped semantic elements based on detection frequency, recency, and consistency. A map database 807 is connected to the semantic element aggregator 803 and stores the aggregated semantic element data for retrieval and further processing. The semantic map 809 represents the output of the system 800, providing a comprehensive representation of semantic elements detected across the environments observed by the distributed edge devices 100A, 100B, 100n.

In some embodiments, the system 800 may detect semantic elements in the video data captured by the edge devices 100A, 100B, 100n. Semantic elements may represent meaningful objects, conditions, or features in the environment, such as road features including lanes, intersections, and traffic signals, retail establishments including store locations, signage, and branding, infrastructure elements including utility poles, construction sites, and barriers, traffic signs, environmental conditions including flooding, snow coverage, and debris, or any other visually identifiable features of interest. The detection process may involve comparing visual embeddings derived from the video data with reference embeddings that represent known semantic element types. The system 800 may associate accurate geolocation data with each detected semantic element. For static elements such as buildings or traffic signs, the system 800 may correlate the detection with the GPS coordinates of the edge device at the time of detection. For elements that appear at a distance from the device, the system 800 may determine the relative position of the element with respect to the edge device and calculate its absolute position using the device's location and orientation data.

In some embodiments, the server 110 may aggregate semantic element data from the plurality of edge devices 100A, 100B, 100n. The aggregation process may identify multiple detections of the same semantic element from different edge devices or at different times. The system 800 may consolidate the multiple detections, refining the estimated location of the semantic element based on the collective observations. This refinement may improve positioning accuracy beyond what any single observation could provide, as measurement errors tend to average out across multiple independent detections. The aggregation process may also consider confidence scores associated with each detection, giving greater weight to high-confidence observations when determining the final position and attributes of a semantic element.

In some embodiments, the map generator 805 may assign confidence scores to mapped semantic elements based on detection frequency, recency, and consistency. Elements that have been detected frequently, recently, and with consistent attributes may receive higher confidence scores, indicating greater reliability in the map. The system 800 may create different map layers for different types of semantic elements, allowing users to selectively view categories of information relevant to their needs. The system 800 may detect and represent changes in semantic elements over time, such as the appearance of new features, the disappearance of previously mapped elements, or modifications to existing elements. The system 800 may also identify and incorporate temporal patterns, such as recurring conditions or cyclical changes, providing insights into how the environment varies over different time scales.

In some embodiments, the transmission of semantic element data from edge devices to the server 110 may be prioritized based on the novelty of the detected elements. When an edge device detects a semantic element that differs from current map data, the edge device may assign higher priority to transmitting this information. Access to the semantic map 809 may be provided through an application programming interface that allows client applications to retrieve map data, query specific element types or locations, and receive updates as the map evolves. The API may support filtering operations that enable users to create customized map views based on element types, confidence thresholds, temporal criteria, or other parameters.

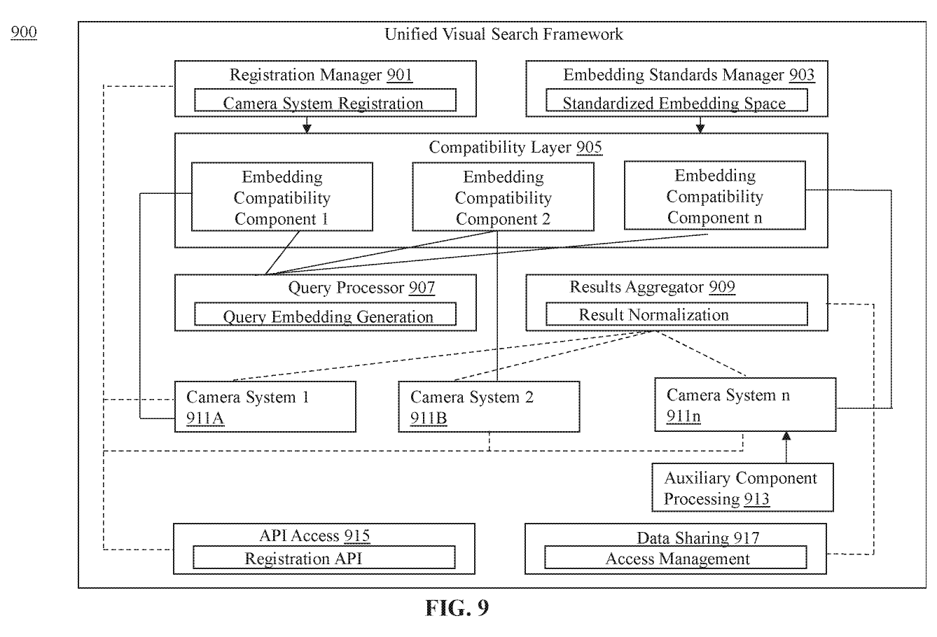

FIG. 9 illustrates a block diagram of a unified visual search framework 900 for integrating heterogeneous camera systems, in accordance with an embodiment of the present disclosure.

The unified visual search framework 900 includes a registration manager 901 configured to handle camera system registration. The registration manager 901 enables diverse camera systems with different hardware configurations to be onboarded into the unified visual search framework 900. Camera systems that may be registered include surveillance cameras with fixed installations, vehicle-mounted cameras with mobile perspectives, and portable camera devices with varying capabilities. The registration manager 901 captures information about each system during the registration process, including processing capabilities such as available CPU, GPU, or specialized accelerators, memory resources including both volatile and persistent storage, and network connectivity characteristics such as bandwidth, latency, and reliability. The registration manager 901 uses the captured information to enable the unified visual search framework 900 to interact appropriately with each system based on the specific capabilities and constraints of the system.

The unified visual search framework 900 includes an embedding standards manager 903 configured to establish and maintain a standardized embedding space for representing visual content across diverse systems. The standardized embedding space defines a vector format with consistent dimensionality typically ranging from 256 to 512 dimensions. The embedding standards manager 903 defines similarity metrics for comparing vectors within the standardized embedding space, ensuring consistent search behavior regardless of the original source of the visual data. The standardized embedding space creates a common representation for visual content that transcends the differences between camera systems.

The unified visual search framework 900 includes a compatibility layer 905 positioned between the registration manager 901, the embedding standards manager 903, and a plurality of camera systems. The compatibility layer 905 comprises a plurality of embedding compatibility components, each configured for a corresponding camera system based on determined capabilities of the camera system. As shown in FIG. 9, the compatibility layer 905 includes embedding compatibility components configured for a camera system 1 911A, a camera system 2 911B, and a camera system n 911n. The compatibility layer 905 receives input from both the registration manager 901 and the embedding standards manager 903 to configure appropriate embedding compatibility components for each registered camera system.

For each registered camera system, the unified visual search framework 900 determines embedding generation capabilities through a combination of self-reporting and capability testing. The determination identifies whether the system can generate embeddings natively, what format of embeddings the system produces if the system has native embedding generation capability, and what computational resources are available for potential embedding conversion. Based on the assessment, the unified visual search framework 900 configures an appropriate embedding compatibility component that bridges between the native capabilities of the system and the requirements of the unified visual search framework 900.

For camera systems that generate embeddings in a non-standard format, the embedding compatibility component implements a converter that transforms between the native format and the standardized embedding space. The converter may include dimensionality adjustment to match target dimensions, feature mapping to align semantic representations, or a trained adapter neural network that has learned the transformation between the two embedding spaces. The converter preserves the semantic meaning of the visual content while ensuring format compatibility with the rest of the unified visual search framework 900.

In some embodiments, the unified visual search framework 900 implements a version control system for embedding standards. The version control system tracks different versions of embedding formats and maintains backward compatibility with multiple versions of embedding formats. When embedding standards are updated to improve performance or capabilities, the unified visual search framework 900 ensures that compatibility components are updated accordingly to preserve interoperability across the platform.

The unified visual search framework 900 includes a query processor 907 configured to receive search queries and perform query embedding generation. The query processor 907 communicates with the compatibility layer 905 to distribute search queries to the plurality of camera systems via respective embedding compatibility components. When distributing search queries across the integrated platform, the query processor 907 accounts for the varying capabilities of different camera systems. For each system, the query processor 907 determines the most appropriate form of the search query 105 based on the capabilities of the system and the embedding compatibility component in place. The determination may result in the query being sent as an embedding vector to systems that directly support embedding comparison, as textual description data to systems that perform text-to-embedding conversion, or as image example data to systems that can perform image similarity comparisons.

The unified visual search framework 900 includes a results aggregator 909 configured to perform result normalization and combine search results received from the plurality of camera systems through the compatibility layer 905. The results aggregator 909 normalizes confidence scores to account for known differences in embedding quality across different camera systems. The normalization may involve applying system-specific scaling factors or transformations to create a consistent confidence scale across the entire platform. In some embodiments, the results aggregator 909 weights results based on known performance characteristics of each camera system's embedding generation. The results aggregator 909 may also convert result embeddings from camera-specific formats to the standardized embedding space to enable consistent post-processing and comparison of results from different sources.

The unified visual search framework 900 includes an auxiliary component processing 913 connected to the camera system n 911n. The auxiliary component processing 913 provides additional processing capabilities for camera systems that lack sufficient native processing power for embedding generation. The auxiliary component processing 913 may receive visual data from a camera system, generate standardized embeddings, and store the standardized embeddings for searching. In some embodiments, the auxiliary component processing 913 includes a vision processing unit configured to generate visual feature vectors and an adapter module configured to transform the visual feature vectors into standardized embeddings. The auxiliary component processing 913 extends the unified search capabilities to legacy or limited-capability camera systems that would otherwise be incompatible with the unified visual search framework 900.

The unified visual search framework 900 includes an API access 915 that provides a registration API enabling third-party camera system operators to register their systems with the unified visual search framework 900. The API access 915 includes interfaces for declaring system capabilities, establishing connectivity, and managing ongoing participation in the unified visual search framework 900. The registration process includes verification steps to ensure that connecting systems meet minimum requirements for data quality and security.

The unified visual search framework 900 includes a data sharing 917 component that handles access management and establishes data sharing agreements with operators of registered camera systems. The data sharing 917 component manages access permissions to search results based on the data sharing agreements. The data sharing agreements specify terms for data access, usage limitations, privacy requirements, and any compensation arrangements for data contributions. The data sharing 917 component ensures that each participant's data is used in accordance with established terms.

In some embodiments, the unified visual search framework 900 implements federated learning techniques that enable continuous improvement of embedding models across the device fleet without centralizing sensitive data. The federated learning techniques may allow individual edge devices to contribute to model refinement by computing local updates based on their captured visual data. These local updates may be aggregated at the server level to improve the overall embedding generation capabilities while preserving the privacy of visual data captured by the camera systems. The federated learning approach may enable the unified visual search framework 900 to adapt to new visual concepts, improve search accuracy over time, and accommodate domain-specific requirements without requiring transmission of raw visual data to centralized servers.

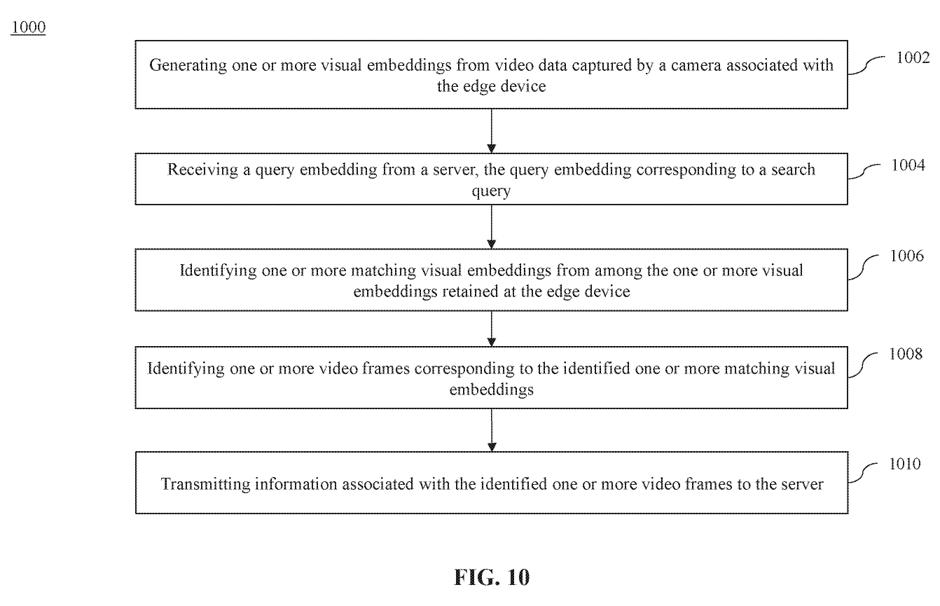

FIG. 10 illustrates a flowchart for a method 1000 for searching visual data at the edge device 100A, in accordance with an embodiment of the present disclosure. The method 1000 may be performed by the searching apparatus 103.

At step 1002, the method 1000 may include generating, at the edge device 100A, one or more visual embeddings from video data captured by a camera associated with the edge device. The one or more visual embeddings may indicate semantic characteristics of visual content represented in the video data. As described previously, the one or more visual embeddings may comprise compact numerical representations of the visual content that capture the semantic essence of visual scenes while requiring less storage space than the original video data. In some embodiments, the one or more visual embeddings may comprise fixed-dimensional vector representations of the semantic characteristics of the video data. The generation of the one or more visual embeddings may involve processing the video data using the feature extractor to generate visual feature vectors and transforming the visual feature vectors into visual embeddings using an adapter module.

At step 1004, the method 1000 may include receiving, at the edge device 100A, the query embedding from the server 110. The query embedding may correspond to the search query 105. The search query 105 may comprise a textual description of visual content to be located, an image-based query, or a combination of textual query data and visual query data.

At step 1006, the method 1000 may include identifying, at the edge device 100A, the one or more matching visual embeddings from among the one or more visual embeddings retained at the edge device 100A. The one or more matching visual embeddings may be identified by comparing the query embedding with the one or more visual embeddings. The comparison may involve calculating similarity scores between the query embedding and each stored visual embedding using metrics such as cosine similarity or Euclidean distance. The edge device 100A may identify matches by selecting visual embeddings whose similarity scores exceed a specified threshold.

At step 1008, the method 1000 may include identifying, at the edge device 100A, the one or more video frames corresponding to the identified one or more matching visual embeddings.

At step 1010, the method 1000 may include transmitting, from the edge device 100A, information associated with the identified one or more video frames to the server 110. Depending on system configuration and available bandwidth, the information may include metadata about the matches, such as timestamp, location, and confidence score, preview images of the matching frames, or video segments containing the matches. The server 110 may receive responses from multiple edge devices and aggregate the responses to produce search results.

In some embodiments, the method 1000 may further include applying privacy processing to the video data captured by the camera associated with the edge device prior to generating the one or more visual embeddings. The privacy processing may obscure privacy-sensitive visual elements represented in the video data, such as faces or identifying markings. The one or more visual embeddings generated from the privacy-processed video data may not enable reconstruction of privacy-sensitive visual elements obscured by the privacy processing.

In some embodiments, the method 1000 may further include associating geolocation data with each of the one or more visual embeddings. The geolocation data may indicate a location at which the video data corresponding to the respective visual embedding was captured. The geolocation data may be transmitted to the server along with the information about the identified one or more video frames.

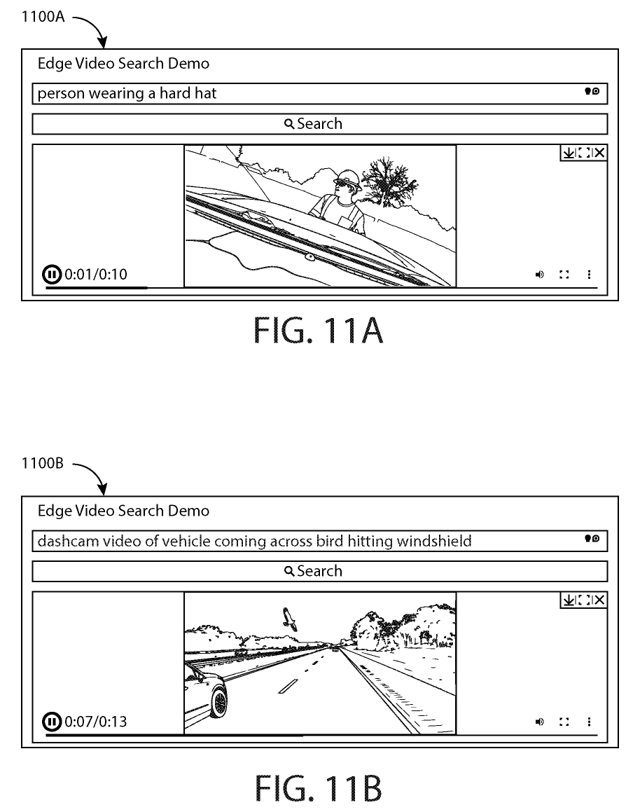

FIGS. 11A-11B illustrate example search interfaces displaying search results, in accordance with embodiments of the present disclosure. The search interfaces demonstrate the open-vocabulary search capabilities of the system, allowing users to search for arbitrary concepts expressed in natural language without requiring predefined categories of objects or scenes.

FIG. 11A illustrates a first search interface 1100A displaying search results for a search query. The first search interface 1100A displays a search query for “person wearing a hard hat” and shows a video result featuring an individual wearing a hard hat and high-visibility clothing. The first search interface 1100A includes a video playback timeline indicating a timestamp of the video result. The first search interface 1100A demonstrates the ability of the system to detect specific combinations of objects and attributes, such as a person wearing particular safety equipment. The first search interface 1100A includes a search button and video playback controls for interacting with the search results.

FIG. 11B illustrates a second search interface 1100B displaying search results for a different search query. The second search interface 1100B displays a search query for “dashcam video of vehicle coming across bird hitting windshield” and shows a corresponding video result captured from a vehicle's perspective on a highway. The video result depicts a bird in mid-flight near a windshield area of the vehicle. The second search interface 1100B demonstrates the capability of the system to identify unusual or unexpected occurrences captured by vehicle-mounted cameras. The second search interface 1100B includes a search button and video playback controls similar to the first search interface 1100A.

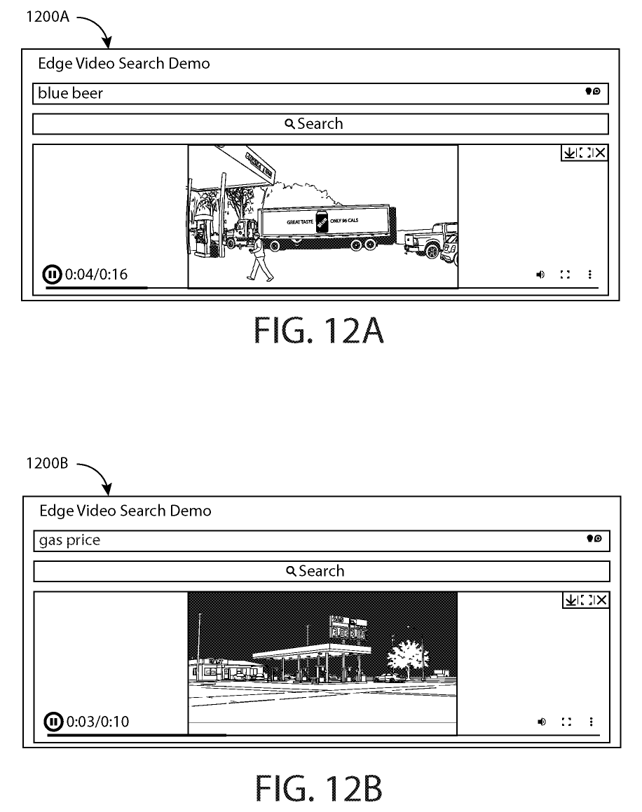

FIGS. 12A-12B illustrate search interfaces displaying search results for brand detection, in accordance with an embodiment of the present disclosure. The search interfaces demonstrate the capability of the system to recognize and locate commercial and retail-related visual content across distributed edge device observations.

FIG. 12A illustrates a first search interface 1200A displaying search results for a brand detection query. The first search interface 1200A displays search results for a “Blue beer” query, with a video player showing a delivery truck bearing Blue Beer branding captured at a gas station location. The first search interface 1200A demonstrates the capability of the system to identify specific brand elements across distributed edge device observations. The first search interface 1200A includes a search bar at the top portion of the interface, a search button, and video playback controls at the bottom portion of a video display area.

FIG. 12B illustrates a second search interface 1200B displaying search results for retail-specific visual elements. The second search interface 1200B displays search results for a “gas price” query, with a video player showing a nighttime scene of a gas station with illuminated price signage. The second search interface 1200B demonstrates the ability of the system to recognize and locate retail-specific visual elements such as fuel pricing information. The second search interface 1200B includes a search bar, a search button, and video playback controls similar to the first search interface 1200A.

The search interfaces illustrated in FIGS. 11A-11B and 12A - 12B demonstrate the diverse search capabilities enabled by the edge video search system. The system may detect specific combinations of objects and attributes, identify unusual events, recognize brand elements, and locate retail-specific information using natural language queries. The open-vocabulary search approach allows users to formulate queries describing visual content without being limited to predefined object categories or detection classes. The search interfaces may receive search queries, transmit query embeddings to edge devices, and display aggregated search results received from the edge devices.

In some embodiments, the system may support a range of commercial applications that leverage distributed visual search capabilities. For example, brand visibility analytics may utilize cameras mounted on vehicles to measure how frequently brand logos, storefronts, or advertisements appear across different geographic areas. The system may generate geographic distribution maps indicating regions where specific brands have a strong visual presence and may quantify “brand impressions” by counting occurrences of brand exposure. Branded vehicles may be analyzed as moving billboards to measure return on investment for fleet branding. Additional applications may include competitive intelligence, such as monitoring competitors’ branding or store locations, retail analytics for tracking store openings, closures, or signage changes, and supply chain analytics for monitoring logistics activity, including loading dock congestion or shipping patterns.

The disclosed system may provide several advantages over conventional visual data search approaches. By performing search operations in a distributed manner and transmitting embeddings or results instead of raw video, the system may significantly reduce bandwidth usage while improving scalability, privacy protection, and real‑time performance. The embedding‑based approach may require substantially less storage than raw video archives while maintaining effective search capability, with low latency and high precision and recall for common queries. Privacy‑preserving mechanisms, including one‑way embedding transformations and authorization‑based access controls, may protect sensitive information while enabling search functionality. The adapter mechanism may enable open‑vocabulary, cross‑modal search without predefined object categories, and a standardized embedding space may allow integration across heterogeneous camera systems. Collectively, these features may support continuously updated semantic maps and analytics accessible through APIs, providing valuable insights across applications without requiring centralized video storage or dedicated mapping infrastructure.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereof are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications, such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for searching visual data at an edge device, the method comprising:
generating, at the edge device, one or more visual embeddings from video data captured by a camera associated with the edge device, wherein the one or more visual embeddings indicate semantic characteristics of visual content represented in the video data;
receiving, at the edge device, a query embedding from a server, the query embedding corresponding to a search query;
identifying, at the edge device, one or more matching visual embeddings from among the one or more visual embeddings retained at the edge device by comparing the query embedding with the one or more visual embeddings retained at the edge device;
identifying, at the edge device, one or more video frames corresponding to the identified one or more matching visual embeddings; and
transmitting, from the edge device, information associated with the identified one or more video frames to the server.

2. The method as claimed in claim 1, wherein generating the one or more visual embeddings comprises:
processing the video data using a feature extractor executed at the edge device to produce visual feature data; and
applying an embedding transformation to the visual feature data to generate the one or more visual embeddings.

3. The method as claimed in claim 2, wherein:
processing the video data comprises processing the video data using pre-trained parameters that remain unchanged during the processing of the video data; and
applying the embedding transformation comprises transforming the visual feature data from a feature space associated with the processing to an embedding space different from the feature space, the embedding space being aligned with textual query data, and producing visual embeddings of fixed dimensionality in the embedding space.

4. The method as claimed in claim 3, further comprising:
receiving, at the edge device, update information for the embedding transformation; and
updating the embedding transformation at the edge device based on the received update information.

5. The method as claimed in claim 1, wherein the one or more visual embeddings comprise fixed-dimensional vector representations of the semantic characteristics of the video data.

6. The method as claimed in claim 1, wherein identifying the one or more matching visual embeddings comprises:
determining a similarity score between the query embedding and at least one of the one or more visual embeddings;
determining whether the similarity score exceeds a similarity threshold; and
identifying the one or more matching visual embeddings based on the determination.

7. The method as claimed in claim 6, further comprising:
dynamically adjusting the similarity threshold based on computational resources available at the edge device,
wherein determining whether the similarity score exceeds the similarity threshold comprises determining whether the similarity score exceeds the dynamically adjusted similarity threshold.

8. The method as claimed in claim 1, further comprising:
determining, at the edge device, an authorization level associated with the search query corresponding to the received query embedding; and
applying, at the edge device, a privacy filter to the identified one or more video frames based on the determined authorization level prior to transmitting the information associated with the identified one or more video frames to the server.

9. The method as claimed in claim 1, wherein transmitting the information associated with the identified one or more video frames comprises:
determining a confidence score for each of the identified one or more video frames;
selecting at least one video frame from among the identified one or more video frames having a confidence score above a predefined threshold; and
transmitting the selected at least one video frame to the server.

10. The method as claimed in claim 1, further comprising:
applying privacy processing to the video data captured by the camera associated with the edge device prior to generating the one or more visual embeddings.

11. The method as claimed in claim 10, wherein the one or more visual embeddings generated from the privacy-processed video data do not enable reconstruction of privacy-sensitive visual elements obscured by the privacy processing.

12. The method as claimed in claim 10, wherein applying the privacy processing comprises obscuring at least one of faces or identifying markings represented in the video data.

13. The method as claimed in claim 1, further comprising:
associating geolocation data with each of the one or more visual embeddings, the geolocation data indicating a location at which the video data corresponding to the respective visual embedding was captured.

14. The method as claimed in claim 1, wherein the query embedding received at the edge device corresponds to a search query comprising a combination of textual query data and visual query data.

15. The method as claimed in claim 1, wherein the query embedding corresponds to a search query comprising textual query data without visual query data.

16. A system for searching visual data, the system comprising:
a server comprising one or more processors and memory storing instructions executable by the one or more processors; and
a plurality of edge devices in communication with the server, each edge device of the plurality of edge devices comprising:
at least one processor; and
memory storing instructions executable by the at least one processor,
wherein the memory of an edge device of the plurality of edge devices stores instructions that, when executed by the at least one processor of the edge device, cause the edge device to:
generate one or more visual embeddings from video data captured by a camera associated with the edge device, the one or more visual embeddings indicating semantic characteristics of visual content represented in the video data;
receive a query embedding transmitted from the server, the query embedding corresponding to a search query;
identify one or more matching visual embeddings from among the one or more visual embeddings retained in the edge device by comparing the query embedding with the one or more visual embeddings;
identify one or more video frames corresponding to the identified one or more matching visual embeddings; and
transmit information associated with the identified one or more video frames to the server, and
wherein the memory of the server stores instructions that, when executed by the one or more processors, cause the server to:
receive the search query;
generate the query embedding based on the search query;
transmit the query embedding to the plurality of edge devices; and
generate a search result by aggregating information received from the plurality of edge devices.

17. The system as claimed in claim 16, wherein the memory of the server further stores instructions that, when executed by the one or more processors, cause the server to:
select a set of edge devices from among the plurality of edge devices based on the search query and stored information indicating at least one of visual coverage, geographic location, temporal availability, or processing capability of the plurality of edge devices; and
transmit the query embedding to the selected set of edge devices.

18. The system as claimed in claim 16, wherein the memory of the edge device further stores instructions that, when executed by the at least one processor, cause the edge device to:
process the video data using a feature extractor configured to produce visual feature data using pre-trained parameters that remain unchanged during the processing; and
apply an embedding transformation to the visual feature data to produce the one or more visual embeddings, wherein the one or more visual embeddings have a fixed dimensionality in an embedding space aligned with textual query data, the embedding space being different from a feature space of the feature extractor.

19. The system as claimed in claim 16, wherein the memory of the edge device further stores instructions that,
when executed by the at least one processor of the edge device, cause the edge device to:
apply privacy processing to the video data prior to generating the one or more visual embeddings, the privacy processing obscuring privacy-sensitive visual elements represented in the video data; and
generate the one or more visual embeddings, wherein the privacy-sensitive visual elements obscured by the privacy processing are not reconstructable from the one or more visual embeddings.

20. A system for searching visual data across heterogeneous edge devices, comprising:
a server comprising one or more processors and memory; and
a plurality of edge devices in communication with the server, the plurality of edge devices including at least:
a first edge device comprising a first camera, a first vision model configured to generate first visual feature vectors in a first feature space, and a first adapter module configured to transform the first visual feature vectors into visual embeddings in a shared embedding space; and
a second edge device comprising a second camera, a second vision model different from the first vision model and configured to generate second visual feature vectors in a second feature space different from the first feature space, and a second adapter module different from the first adapter module and configured to transform the second visual feature vectors into visual embeddings in the shared embedding space, wherein the memory of the server stores instructions that, when executed, cause the server to:
receive a search query;
generate a query embedding in the shared embedding space based on the search query;
transmit the query embedding to the first edge device and the second edge device for comparison against the visual embeddings stored at each respective edge device; and
aggregate, into a search result, information received from the first edge device and the second edge device identifying matching video frames.
